(19) United States
(12) Patent Application Publication
(10) Pub. No.: US 2025/0168868 A1
(43) Pub. Date: May 22, 2025

(54) TECHNIQUES FOR SCHEDULING PASSIVE INTERNET OF THINGS COMMUNICATIONS

(71) Applicant: QUALCOMM INCORPORATED, San Diego, CA (US)

(72) Inventors: Zhikun Wu, Beijing (CN); Yuchul Kim, San Diego, CA (US); Ahmed Elshafie, San Diego, CA (US); Linhai He, San Diego, CA (US); Seyedkianoush Hosseini, San Diego, CA (US); Huilin Xu, Temecula, CA (US); Yu Zhang, San Diego, CA (US)

(21) Appl. No.: 18/842,355

(22) PCT Filed: May 6, 2022
(86) PCT No.: PCT/CN2022/091103

§ 371 Date: Aug. 28, 2024

(51) Int. Cl. H04W 72/40; H04W 24/10; H04W 72/12; H04W 84/18

(52) U.S. Cl. CPC H04W 72/40; H04W 24/10; H04W 72/12; H04W 84/18

(57) ABSTRACT

Methods, systems, and devices for wireless communication are described. A user equipment (UE) may transmit a passive Intemet of Things (IoT) traffic report that indicates a set of passive IoT communications to be performed between the UE and one or more passive IoT devices. The UE may receive a scheduling grant from a network entity in response to the passive IoT traffic report. The scheduling grant may indicate a set of time and frequency resources allocated for the set of passive IoT communications between the UE and the one or more passive IoT devices. Accordingly, the UE may perform the set of passive IoT communications with the one or more passive IoT devices using the set of time and frequency resources indicated by the scheduling grant. The techniques described herein may enable the UE to perform passive IoT communications with fewer signal collisions and lower communication resource overhead.

### CROSS REFERENCE

The present Application is a 371 national stage filing of International PCT Application No. PCT/CN2022/091103 by Wu et al. entitled “TECHNIQUES FOR SCHEDULING PASSIVE INTERNET OF THINGS COMMUNICATIONS,” filed May 6, 2022, which is assigned to the assignee hereof, and which is expressly incorporated by reference in its entirety herein.

### TECHNICAL FIELD

The following relates to wireless communication, including techniques for scheduling passive Internet of Things (IoT) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support NR communications as well as Internet of Things (IoT) communications. In some cases, however, NR communications and IoT communications may utilize different waveforms or modulation schemes, which may increase the complexity of scheduling NR communications and IoT communications in the same radio frequency (RF) spectrum band.

### SUMMARY

The described techniques relate to improved methods, systems, devices, and apparatuses that support techniques for scheduling passive Internet of Things (IoT) communications. For example, the described techniques provide for scheduling passive IoT communications with greater efficiency and lower communication resource overhead. In accordance with the techniques described herein, a user equipment (UE) may transmit a passive IoT traffic report that indicates a set of passive IoT communications to be performed between the UE and one or more passive IoT devices. The UE may receive a scheduling grant from a network entity in response to the passive IoT traffic report. The scheduling grant may indicate a set of time and frequency resources allocated for the set of passive IoT communications between the UE and the one or more passive IoT devices. Accordingly, the UE may perform the set of passive IoT communications with the one or more passive IoT devices using the set of time and frequency resources indicated by the scheduling grant. The techniques described herein may enable the UE to perform the set of passive IoT communications with fewer signal collisions and lower communication resource overhead, among other benefits.

A method for wireless communication at a UE is described. The method may include transmitting a passive IoT traffic report that indicates a set of passive IoT communications to be performed between the UE and one or more passive IoT devices, receiving, based on the passive IoT traffic report, a scheduling grant that indicates a set of time and frequency resources allocated for the set of passive IoT communications between the UE and the one or more passive IoT devices, and performing the set of passive IoT communications with the one or more passive IoT devices using the set of time and frequency resources indicated by the scheduling grant.

An apparatus for wireless communication at a UE is described. The apparatus may include at least one processor and memory coupled (e.g., operatively, communicatively, functionally, electronically, or electrically) to the at least one processor, the memory storing instructions executable by the at least one processor to cause the UE to transmit a passive IoT traffic report that indicates a set of passive IoT communications to be performed between the UE and one or more passive IoT devices, receive, based on the passive IoT traffic report, a scheduling grant that indicates a set of time and frequency resources allocated for the set of passive IoT communications between the UE and the one or more passive IoT devices, and perform the set of passive IoT communications with the one or more passive IoT devices using the set of time and frequency resources indicated by the scheduling grant.

Another apparatus for wireless communication at a UE is described. The apparatus may include means for transmitting a passive IoT traffic report that indicates a set of passive IoT communications to be performed between the UE and one or more passive IoT devices, means for receiving, based on the passive IoT traffic report, a scheduling grant that indicates a set of time and frequency resources allocated for the set of passive IoT communications between the UE and the one or more passive IoT devices, and means for performing the set of passive IoT communications with the one or more passive IoT devices using the set of time and frequency resources indicated by the scheduling grant.

A non-transitory computer-readable medium storing code for wireless communication at a UE is described. The code may include instructions executable by at least one processor to cause the UE to transmit a passive IoT traffic report that indicates a set of passive IoT communications to be performed between the UE and one or more passive IoT devices, receive, based on the passive IoT traffic report, a scheduling grant that indicates a set of time and frequency resources allocated for the set of passive IoT communications between the UE and the one or more passive IoT devices, and perform the set of passive IoT communications with the one or more passive IoT devices using the set of time and frequency resources indicated by the scheduling grant.

In some examples of the method, apparatuses, and non-transitory computer-readable medium described herein, transmitting the passive IoT traffic report may include operations, features, means, or instructions for signaling a quantity of the one or more passive IoT devices in the passive IoT traffic report.

In some examples of the method, apparatuses, and non-transitory computer-readable medium described herein, a quantity of resources in the set of time and frequency resources indicated by the scheduling grant corresponds to the quantity of the one or more passive IoT devices signaled by the passive IoT traffic report.

In some examples of the method, apparatuses, and non-transitory computer-readable medium described herein, transmitting the passive IoT traffic report may include operations, features, means, or instructions for signaling a default value corresponding to an unknown quantity of the one or more passive IoT devices in the passive IoT traffic report.

In some examples of the method, apparatuses, and non-transitory computer-readable medium described herein, a quantity of resources in the set of time and frequency resources indicated by the scheduling grant corresponds to the default value signaled by the passive IoT traffic report.

In some examples of the method, apparatuses, and non-transitory computer-readable medium described herein, transmitting the passive IoT traffic report may include operations, features, means, or instructions for signaling a cast type associated with the set of passive IoT communications in the passive IoT traffic report, where the cast type includes one or more of a broadcast type, a unicast type, or a groupcast type.

In some examples of the method, apparatuses, and non-transitory computer-readable medium described herein, the cast type signaled in the passive IoT traffic report indicates a quantity of the one or more passive IoT devices.

Some examples of the method, apparatuses, and non-transitory computer-readable medium described herein may further include operations, features, means, or instructions for transmitting a message that indicates collision information associated with the set of passive IoT communications, an estimated time duration of the set of passive IoT communications, or both.

In some examples of the method, apparatuses, and non-transitory computer-readable medium described herein, the collision information indicates a probability of collisions occurring during the set of passive IoT communications, a probability of the set of time and frequency resources including unused slots, or both.

Some examples of the method, apparatuses, and non-transitory computer-readable medium described herein may further include operations, features, means, or instructions for receiving, based on the message, a second scheduling grant that indicates a second set of time and frequency resources allocated for the set of passive IoT communications.

Some examples of the method, apparatuses, and non-transitory

computer-readable medium described herein may further include operations, features, means, or instructions for transmitting a request for a second scheduling grant based on a quantity of the one or more passive IoT devices, an estimated time duration of the set of passive IoT communications, a quantity of resources allocated by the scheduling grant, a time duration of resources allocated by the scheduling grant, or a combination thereof, and receiving the second scheduling grant based on a time duration between transmission of the request and a start of the second scheduling grant satisfying a threshold, where the second scheduling grant indicates a second set of time and frequency resources allocated for the set of passive IoT communications.

Some examples of the method, apparatuses, and non-transitory computer-readable medium described herein may further include operations, features, means, or instructions for transmitting a request for a continuous scheduling grant within a time duration of the set of time and frequency resources, and performing the set of passive IoT communications using a second set of time and frequency resources in accordance with the continuous scheduling grant.

Some examples of the method, apparatuses, and non-transitory computer-readable medium described herein may further include operations, features, means, or instructions for transmitting an indication of at least one unused time or frequency resource upon completion of the set of passive IoT communications.

A method for wireless communication at a network entity is described. The method may include obtaining a passive IoT traffic report that indicates a set of passive IoT communications to be performed between a UE and one or more passive IoT devices, determining a set of time and frequency resources to allocate for the set of passive IoT communications between the UE and the one or more passive IoT devices based on the passive IoT traffic report, and outputting a scheduling grant that indicates the set of time and frequency resources allocated for the set of passive IoT communications between the UE and the one or more passive IoT devices.

An apparatus for wireless communication at a network entity is described. The apparatus may include at least one processor and memory coupled (e.g., operatively, communicatively, functionally, electronically, or electrically) to the at least one processor, the memory storing instructions executable by the at least one processor to cause the network entity to obtain a passive IoT traffic report that indicates a set of passive IoT communications to be performed between a UE and one or more passive IoT devices, determine a set of time and frequency resources to allocate for the set of passive IoT communications between the UE and the one or more passive IoT devices based on the passive IoT traffic report, and output a scheduling grant that indicates the set of time and frequency resources allocated for the set of passive IoT communications between the UE and the one or more passive IoT devices.

Another apparatus for wireless communication at a network entity is described. The apparatus may include means for obtaining a passive IoT traffic report that indicates a set of passive IoT communications to be performed between a UE and one or more passive IoT devices, means for determining a set of time and frequency resources to allocate for the set of passive IoT communications between the UE and the one or more passive IoT devices based on the passive IoT traffic report, and means for outputting a scheduling grant that indicates the set of time and frequency resources allocated for the set of passive IoT communications between the UE and the one or more passive IoT devices.

A non-transitory computer-readable medium storing code for wireless communication at a network entity is described. The code may include instructions executable by at least one processor to cause the network entity to obtain a passive IoT traffic report that indicates a set of passive IoT communications to be performed between a UE and one or more passive IoT devices, determine a set of time and frequency resources to allocate for the set of passive IoT communications between the UE and the one or more passive IoT devices based on the passive IoT traffic report, and output a scheduling grant that indicates the set of time and frequency resources allocated for the set of passive IoT communications between the UE and the one or more passive IoT devices.

In some examples of the method, apparatuses, and non-transitory computer-readable medium described herein, the passive IoT traffic report signals a quantity of the one or more passive IoT devices.

In some examples of the method, apparatuses, and non-transitory computer-readable medium described herein, determining the set of time and frequency resources may include operations, features, means, or instructions for determining a quantity of resources to include in the set of time and frequency resources based on the quantity of the one or more passive IoT devices signaled by the passive IoT traffic report.

In some examples of the method, apparatuses, and non-transitory computer-readable medium described herein, the passive IoT traffic report signals a default value corresponding to an unknown quantity of the one or more passive IoT devices.

In some examples of the method, apparatuses, and non-transitory computer-readable medium described herein, determining the set of time and frequency resources may include operations, features, means, or instructions for determining a quantity of resources to include in the set of time and frequency resources based on the default value signaled by the passive IoT traffic report.

In some examples of the method, apparatuses, and non-transitory computer-readable medium described herein, the passive IoT traffic report signals a cast type associated with the set of passive IoT communications, the cast type including one or more of a broadcast type, a unicast type, or a groupcast type.

Some examples of the method, apparatuses, and non-transitory computer-readable medium described herein may further include operations, features, means, or instructions for determining a quantity of the one or more passive IoT devices based on the cast type signaled in the passive IoT traffic report.

Some examples of the method, apparatuses, and non-transitory computer-readable medium described herein may further include operations, features, means, or instructions for obtaining a message that indicates collision information associated with the set of passive IoT communications, an estimated time duration of the set of passive IoT communications, or both.

In some examples of the method, apparatuses, and non-transitory computer-readable medium described herein, the collision information indicates a probability of collisions occurring during the set of passive IoT communications, a probability of the set of time and frequency resources including unused slots, or both.

Some examples of the method, apparatuses, and non-transitory computer-readable medium described herein may further include operations, features, means, or instructions for outputting a second scheduling grant that indicates a second set of time and frequency resources allocated for the set of passive IoT communications based on the message.

Some examples of the method, apparatuses, and non-transitory computer-readable medium described herein may further include operations, features, means, or instructions for obtaining a request for a continuous scheduling grant within a time duration of the set of time and frequency resources, and allocating a second set of time and frequency resources for the set of passive IoT communications in accordance with the continuous scheduling grant.

Some examples of the method, apparatuses, and non-transitory computer-readable medium described herein may further include operations, features, means, or instructions for receiving an indication of at least one unused time or frequency resource in the set of time and frequency resources allocated for the set of passive IoT communications, and allocating the at least one unused time or frequency resource to a second UE that is different from the UE.

### BRIEF DESCRIPTION OF THE DRAWINGS

FIGS. 1 and 2 illustrate examples of wireless communications systems that support techniques for scheduling passive Internet of Things (IoT) communications in accordance with one or more aspects of the present disclosure.

FIGS. 3A and 3B illustrate examples of resource diagrams that support techniques for scheduling passive IoT communications in accordance with one or more aspects of the present disclosure.

FIGS. 4A and 4B illustrate examples of resource diagrams that support techniques for scheduling passive IoT communications in accordance with one or more aspects of the present disclosure.

FIGS. 5A and 5B illustrate examples of resource diagrams that support techniques for scheduling passive IoT communications in accordance with one or more aspects of the present disclosure.

FIG. 6 illustrates an example of a process flow that supports techniques for scheduling passive IoT communications in accordance with one or more aspects of the present disclosure.

FIGS. 7 and 8 show block diagrams of devices that support techniques for scheduling passive IoT communications in accordance with one or more aspects of the present disclosure.

FIG. 9 shows a block diagram of a communications manager that supports techniques for scheduling passive IoT communications in accordance with one or more aspects of the present disclosure.

FIG. 10 shows a diagram of a system including a device that supports techniques for scheduling passive IoT communications in accordance with one or more aspects of the present disclosure.

FIGS. 11 and 12 show block diagrams of devices that support techniques for scheduling passive IoT communications in accordance with one or more aspects of the present disclosure.

FIG. 13 shows a block diagram of a communications manager that supports techniques for scheduling passive IoT communications in accordance with one or more aspects of the present disclosure.

FIG. 14 shows a diagram of a system including a device that supports techniques for scheduling passive IoT communications in accordance with one or more aspects of the present disclosure.

FIGS. 15 through 18 show flowcharts illustrating methods that support techniques for scheduling passive IoT communications in accordance with one or more aspects of the present disclosure.

### DETAILED DESCRIPTION

Passive Internet of Things (IoT) devices may refer to communication devices that are capable of performing passive (e.g., low-power) communications using technologies like backscatter and radio frequency identification (RFID). Some wireless communications systems may support both passive IoT communications and New Radio (NR) communications. In some cases, passive IoT communications (also referred to herein as ambient power-enabled IoT communications) and NR communications may utilize different waveforms or modulation schemes. For example, NR communications may utilize orthogonal frequency division multiplexing (OFDM) waveforms, whereas passive IoT communications may utilize single carrier waveforms. These distinctions may result in different scheduling considerations for NR communications and IoT communications.

For NR communications, a network entity may allocate resources to a user equipment (UE) according to a buffer status of the UE (e.g., a quantity of data stored in a buffer of the UE). For passive IoT communications, however, the network entity may allocate resources to the UE based on the number of passive IoT devices participating in the passive IoT communications. If, for example, the UE intends to perform passive IoT communications with an unknown quantity of passive IoT devices, the network entity may be unable to determine an appropriate quantity of resources to allocate for the passive IoT communications. Allocating too few resources to the UE may result in signal collisions and reduced communication reliability, while allocating too many resources to the UE may result in higher communication resource overhead.

Aspects of the present disclosure provide for improving the reliability and efficiency of passive IoT communications between a UE and one or more passive IoT devices (also referred to herein as passive UEs or backscatter devices). In accordance with the techniques described herein, the UE may transmit a passive IoT traffic report prior to initiating passive IoT communications with the one or more passive IoT devices. The passive IoT traffic report may function as a scheduling request for the passive IoT communications, and may include information that enables a network entity to allocate an appropriate quantity of resources for the passive IoT communications. For example, the passive IoT traffic report may indicate a quantity of passive IoT devices participating in the passive IoT communications.

If, for example, the UE intends to communicate with an unknown quantity of passive IoT devices, the UE may include a default value in the passive IoT traffic report. Accordingly, the network entity may allocate a default quantity of resources for the passive IoT communications. If the UE determines that the default quantity of resources provided by the network entity is insufficient for the passive IoT communications, the UE may request additional resources from the network entity. In contrast, if there are unused resources in the default quantity of resources (e.g., if the default quantity of resources is too large), the UE may transmit an indication of the unused resources to the network entity such that the network entity can allocate the unused resources to other communication devices.

Aspects of the present disclosure may be implemented to realize one or more of the following advantages. The described techniques may enable a network entity to schedule passive IoT communications with reduced communication resource overhead. For example, configuring a UE to transmit a passive IoT traffic report to the network entity in accordance with the techniques described herein may enable the network entity to allocate a suitable quantity of resources for the passive IoT communications. Moreover, the described techniques may enable the UE to perform the passive IoT communications with fewer collisions and greater reliability. For example, the network entity may use collision information provided by the UE to dynamically adjust the quantity of resources allocated for the passive IoT communications, which may reduce the likelihood of signal collisions occurring during the passive IoT communications.

Aspects of the disclosure are initially described in the context of wireless communications systems, resource diagrams, and process flows. Aspects of the disclosure are further illustrated by and described with reference to apparatus diagrams, system diagrams, and flowcharts that relate to techniques for scheduling passive IoT communications.

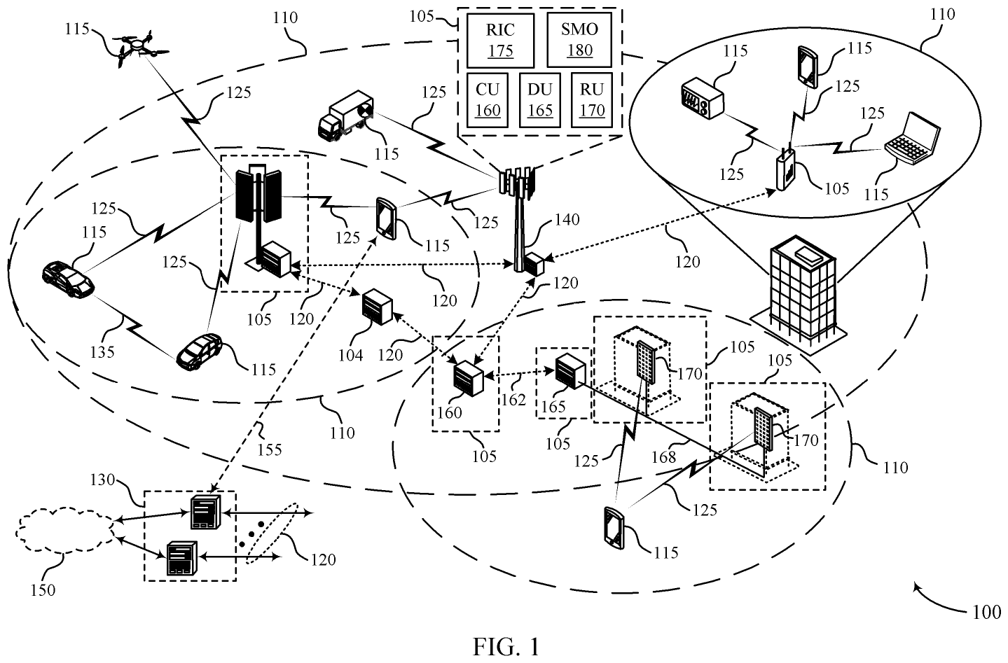

FIG. 1 illustrates an example of a wireless communications system 100 that supports techniques for scheduling passive IoT communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a fifth generation (5G) NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or a computing system may include disclosure of the UE 115, network entity 105, apparatus, device, or the computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for scheduling passive IoT communications, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a Moving Picture Experts Group Layer-3 (MP3) player, or a video device), a camera, a gaming device, a navigation/positioning device (e.g., global navigation satellite system (GNSS) devices based on, for example, global positioning system (GPS), Beidou, global navigation satellite system (GLONASS), or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an IoT device, an Internet of Everything (IoE) device, or a machine type communication (MTC) device, which may be implemented in various articles such as appliances, drones, robots, vehicles, or meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. The techniques disclosed herein may be applicable to MTC or IoT UEs. MTC or IoT UEs may include MTC or enhanced MTC (eMTC), also referred to as category M (CAT-M) or category (CAT) MI UEs, NB-IoT (also referred to as CAT NB1) UEs, as well as other types of UEs. eMTC and NB-IoT may refer to future technologies that are based on or evolve from these technologies. For example, eMTC may include further eMTC (FeMTC), enhanced further eMTC (eFeMTC), and massive MTC (mMTC), and NB-IoT may include enhanced NB-IoT (eNB-IoT), and further enhanced NB-IoT (FeNB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems may support passive IoT technologies., as described herein, passive IoT devices may refer to devices that use passive communication technologies such as backscatter communications. These technologies may be compatible with low-cost and low-power devices. Some commercial communications systems may utilize UHF RFID technologies that employ backscatter communication techniques. However, some UHF RFID systems may be incompatible with NR systems. For example, RFID systems may operate within ISM frequency bands, while NR systems may operate in licensed frequency bands. Interference levels between these systems may or may not be defined. The techniques described herein generally provide for supporting coexistence between passive IoT and NR.

Passive IoT devices may be capable of using envelope decoding techniques for reception and backscatter communication techniques for transmission. To perform passive IoT communications, a UE 115 may request a scheduling grant from a network entity 105. Accordingly, the network entity 105 may allocate the scheduling grant to the UE 115 such that the UE 115 can use the scheduling grant to perform passive IoT communications with one or more passive IoT devices. In some cases, the UE 115 may apply scheduling grants (e.g., communication resources) from the network entity 105 to conduct passive IoT communications with one or more passive IoT devices (of which the number is known). In other cases, the UE 115 may apply scheduling grants from the network entity 105 to conduct passive IoT communications with an unknown quantity of passive IoT devices.

As described herein, passive IoT communications and NR communications may utilize different waveforms and modulation schemes. For example, NR communications may utilize OFDM waveforms, whereas passive IoT communications may utilize single carrier waveforms. Similarly, NR communications may utilize quadrature amplitude modulation (QAM) schemes, whereas passive IoT communications may utilize FM0 or Miller-Modulated Subcarrier (MMS) modulation schemes. Thus, IoT communications and NR communications with the same quantity of data may occupy different resource allocations. The network entity 105 may consider these differences when scheduling IoT communications and NR communications.

In accordance with the techniques described herein, a UE 115 may transmit a passive IoT traffic report to a network entity 105. This passive IoT traffic report may indicate that the UE 115 intends to conduct passive IoT communications with one or more passive IoT devices. Thus, if the UE 115 intends to perform uplink communications with the network entity 105, the UE 115 may transmit a scheduling request to the network entity 105. In contrast, if the UE 115 intends to perform sidelink communications with another UE 115, the UE 115 may transmit a sidelink scheduling request to the network entity 105. If, however, the UE 115 intends to perform passive IoT communications with one or more passive IoT devices, the UE 115 may transmit a passive IoT traffic report (equivalently referred to herein as a passive IoT scheduling request) to the network entity 105.

Aspects of the wireless communications system 100 may be implemented to realize one or more of the following advantages. The techniques and operations described with reference to FIG. 1 may enable a network entity 105 to schedule passive IoT communications with reduced communication resource overhead. For example, configuring a UE 115 to transmit a passive IoT traffic report to the network entity 105 in accordance with the techniques described herein may enable the network entity 105 to allocate a suitable quantity of resources for the passive IoT communications. Moreover, the described techniques may enable the UE 115 to perform the passive IoT communications with fewer collisions and greater reliability. For example, the network entity 105 may use collision information provided by the UE 115 to dynamically adjust the quantity of resources allocated for the passive IoT communications, which may reduce the likelihood of signal collisions occurring during the passive IoT communications.

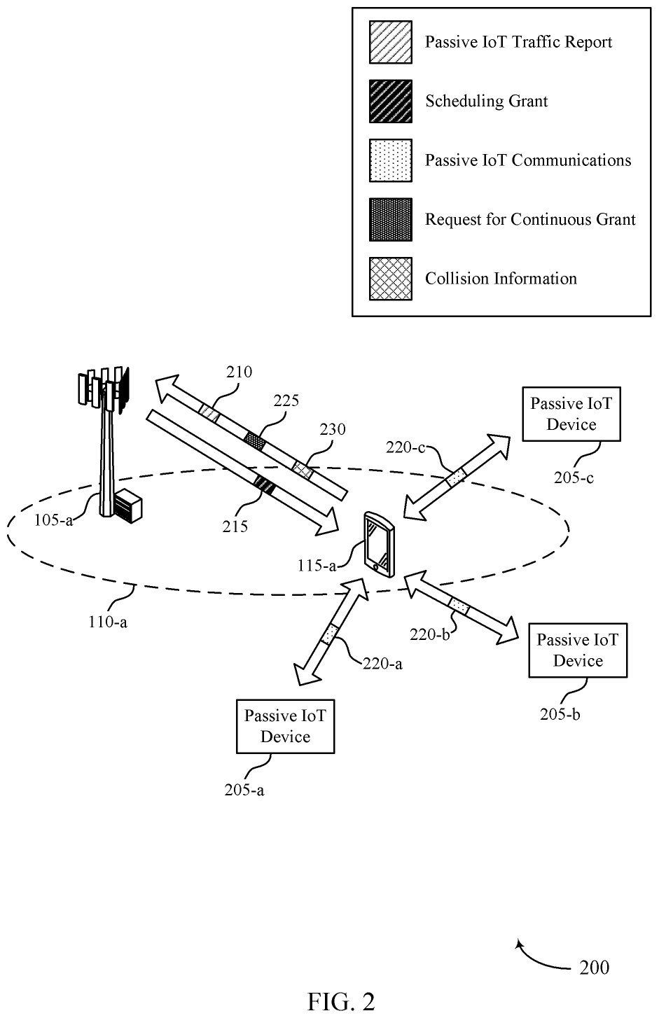

FIG. 2 illustrates an example of a wireless communications system 200 that supports techniques for scheduling passive IoT communications in accordance with one or more aspects of the present disclosure. The wireless communications system 200 may implement or be implemented by aspects of wireless communications system 100. For example, the wireless communications system 200 may include a UE 115-a and a network entity 105-a, which may be examples of corresponding devices described with reference to FIG. 1. The UE 115-a and the network entity 105-a may communicate within a coverage area 110-a, which may be an example of a coverage area 110 described with reference to FIG. 1. The wireless communications system 200 may also include a passive IoT device 205-a, a passive IoT device 205-b, and a passive IoT device 205-c. The UE 115-a may communicate with the passive IoT devices 205 using resources allocated by the network entity 105-a.

The wireless communications system 200 may support NR communications (e.g., between the UE 115-a and the network entity 105-a) and passive IoT communications 220 (e.g., between the UE 115-a and the passive IoT devices 205). For NR communications, the network entity 105-a may allocate resources to the UE 115-a according to a buffer status of the UE 115-a. For the passive IoT communications 220, however, the network entity 105-a may allocate resources to the UE 115-a based on the number of passive IoT devices 205 participating in the passive IoT communications 220. If, for example, the UE 115-a intends to perform the passive IoT communications 220 with an unknown quantity of passive IoT devices 205, the network entity 105-a may be unable to determine an appropriate quantity of resources to allocate for the passive IoT communications 220. Allocating insufficient (e.g., too few) resources to the UE 115-a may result in signal collisions and reduced communication reliability, while allocating extraneous (e.g., too many) resources to the UE 115-a may result in higher communication resource overhead.

In accordance with aspects of the present disclosure, the UE 115-a may transmit a passive IoT traffic report 210 to the network entity 105-a prior to initiating the passive IoT communications 220 with the passive IoT devices 205. In some examples, the passive IoT traffic report 210 may indicate a quantity of the passive IoT devices 205 participating in the passive IoT communications 220. Upon receiving the passive IoT traffic report 210 from the UE 115-a, the network entity 105-a may allocate a suitable quantity of resources to the UE 115-a via the scheduling grant 215. More specifically, the network entity 105-a may allocate resources to the UE 115-a according to the quantity of passive IoT devices 205 that will be participating in the passive IoT communications 220.

If, however, the UE 115-a is unable to determine how many passive IoT devices 205 will be participating in the passive IoT communications 220 prior to transmitting the passive IoT traffic report 210, the UE 115-a may include a default value in (or omit a value from) the passive IoT traffic report 210. This default value may signal (e.g., to the network entity 105-a) that the UE 115-a intends to perform the passive IoT communications 220 with an unknown quantity of passive IoT devices 205. In such examples, the network entity 105-a may allocate a default quantity of resources for the passive IoT communications 220 (e.g., via the scheduling grant 215). Accordingly, the UE 115-a may perform the passive IoT communications 220 using the resources allocated by the scheduling grant 215. For example, the UE 115-a may perform passive IoT communications 220-a with the passive IoT device 205-a, passive IoT communications 220-b with the passive IoT device 205-b, and passive IoT communications 220-c with the passive IoT device 205-c.

If the resources allocated by the scheduling grant 215 are insufficient for the passive IoT communications 220, the UE 115-a may transmit a request 225 for a continuous scheduling grant from the network entity 105-a. The network entity 105-a may, in some examples, allocate the continuous scheduling grant (e.g., a persistent resource allocation) to the UE 115-a in response to the request 225. In some examples, the UE 115-a may transmit collision information 230 to the network entity 105-a. The collision information 230 may indicate a probability of collisions occurring during the passive IoT communications 220, a probability of empty slots occurring during the passive IoT communications 220, or other supplemental information related to the passive IoT communications 220. The network entity 105-a may use the collision information 230 provided by the UE 115-a to dynamically adjust the quantity of resources allocated for the passive IoT communications 220.

Aspects of the wireless communications system 200 may be implemented to realize one or more of the following advantages. The techniques and operations described with reference to FIG. 2 may enable the network entity 105-a to schedule the passive IoT communications 220 with reduced communication resource overhead. For example, configuring the UE 115-a to transmit the passive IoT traffic report 210 to the network entity 105-a in accordance with the techniques described herein may enable the network entity 105-a to allocate a suitable quantity of resources for the passive IoT communications 220. Moreover, the described techniques may enable the UE 115-a to perform the passive IoT communications 220 with fewer collisions and greater reliability. For example, the network entity 105-a may use the collision information 230 provided by the UE 115-a to dynamically adjust the quantity of resources allocated for the passive IoT communications 220, which may reduce the likelihood of signal collisions occurring during the passive IoT communications 220.

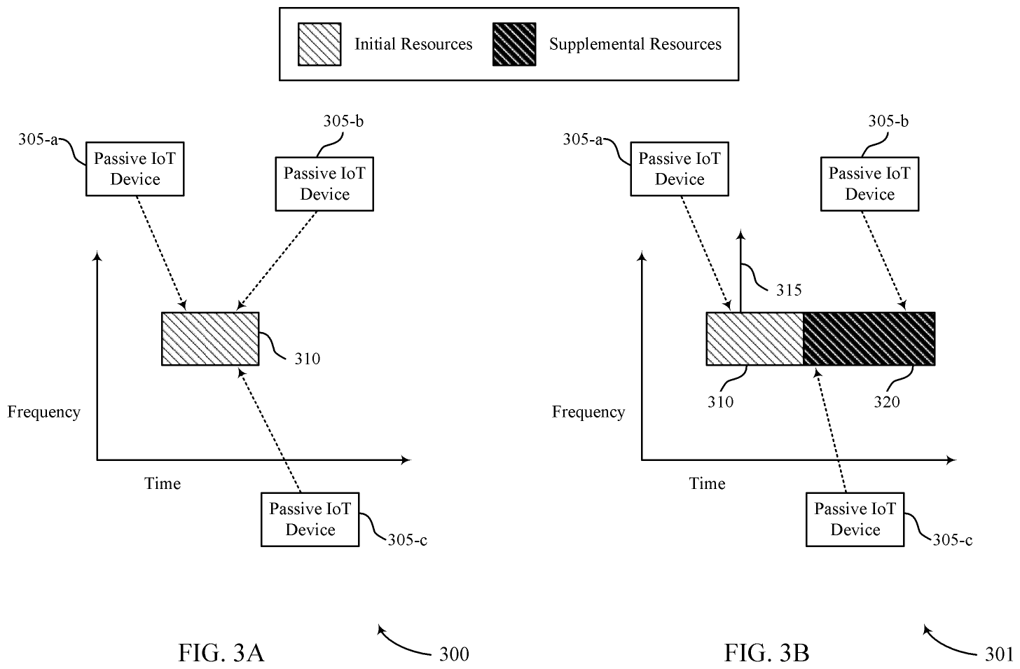

FIGS. 3A and 3B illustrate examples of a resource diagram 300 and a resource diagram 301 that support techniques for scheduling passive IoT communications in accordance with one or more aspects of the present disclosure. The resource diagram 300 and the resource diagram 301 may implement or be implemented by aspects of the wireless communications system 100 or the wireless communications system 200. For example, the resource diagram 300 and the resource diagram 301 may be implemented by a UE 115 or a network entity 105 described with reference to FIGS. 1 and 2. The resource diagram 300 and the resource diagram 301 may include a passive IoT device 305-a, a passive IoT device 305-b, and a passive IoT device 305-c, which may be examples of the passive IoT devices 205 described with reference to FIG. 2. The resource diagram 300 and the resource diagram 301 may support techniques for reducing collisions between passive IoT communications performed by the passive IoT devices 305.

In some wireless communications systems, a UE may transmit a buffer status report to a network entity if the UE has uplink data available for transmission. The buffer status report may indicate a buffer size of the UE (e.g., a quantity of uplink data stored in a buffer of the UE). Accordingly, the network entity may allocate resources to the UE based on the buffer status report. Thus, a quantity of resources allocated to the UE (e.g., for uplink communications) may correspond to a buffer size of the UE. For passive IoT communications, however, the quantity of resources may depend on the number of passive IoT devices 305 (also referred to herein as tags) participating in the passive IoT communications. If insufficient resources are allocated to the UE, the passive IoT communications may result in signal collisions and reduced communication reliability.

To ensure that an appropriate quantity of resources are allocated for the passive IoT communications, the UE may indicate the number of passive IoT devices to the network entity via a passive IoT traffic report (e.g., the passive IoT traffic report 210 described with reference to FIG. 2). In some examples, however, the number of passive IoT devices participating in the passive IoT communications may be unknown. That is, the UE may be unable to determine how many passive IoT devices will be participating in the passive IoT communications before transmitting the passive IoT traffic report. To mitigate this issue, the UE may report a default (e.g., preconfigured) value in the passive IoT traffic report. Alternatively, the UE may omit a value (e.g., a value corresponding to the number of passive IoT devices) from the passive IoT traffic report.

Upon receiving a passive IoT traffic report with a default (or omitted) value for the number of passive IoT devices, the network entity may allocate a default (e.g., preconfigured) quantity of resources for the passive IoT communications. The network entity may allocate these resources to the UE via a scheduling grant (e.g., the scheduling grant 215 described with reference to FIG. 2). In some examples, however, the default quantity of resources allocated by the network entity may include insufficient (e.g., too few) resources or extraneous (e.g., too many) resources. If the default quantity of resources includes insufficient resources, the passive IoT communications may result in signal collisions and interference. This may occur when a relatively large number of passive IoT devices 305 attempt to communicate with the UE using the same resources.

In the example of FIG. 3A, the UE may receive a scheduling grant that indicates a first set of resources 310 (e.g., initial resources) allocated for passive IoT communications between the UE and the passive IoT devices 305. The UE may attempt to perform the passive IoT communications with the passive IoT devices 305 using the first set of resources 310 indicated by the scheduling grant. In some cases, however, a quantity or duration of resources in the first set of resources 310 may be insufficient for the passive IoT communications. For example, if all three of the passive IoT devices 305 use the first set of resources 310 to perform the passive IoT communications, signals from the passive IoT device 305-a may collide with signals from the passive IoT device 305-b. This may reduce the likelihood of successful communications between the UE and the passive IoT devices 305.

In the example of FIG. 3B, the UE may determine that a quantity or duration of resources in the first set of resources 310 are insufficient for the passive IoT communications. The UE may determine this information by measuring or estimating the frequency of signal collisions that occur on the first set of resources. At 315, the UE may transmit collision information (e.g., the collision information 230 described with reference to FIG. 2) to the network entity. Upon receiving this information from the UE, the network entity may allocate a second set of resources 320 (e.g., supplemental resources) for the passive IoT communications between the UE and the passive IoT devices 305. Allocating additional resources to the UE may reduce the likelihood of signal collisions occurring during the passive IoT communications.

Aspects of the resource diagram 300 and the resource diagram 301 may be implemented to realize one or more of the following advantages. The techniques and operations described with reference to FIGS. 3A and 3B may enable a network entity to schedule passive IoT communications with reduced communication resource overhead. For example, configuring a UE to transmit a passive IoT traffic report to the network entity in accordance with the techniques described herein may enable the network entity to allocate a suitable quantity of resources for the passive IoT communications. Moreover, the described techniques may enable the passive IoT devices 305 to perform the passive IoT communications with fewer collisions and greater reliability. For example, the network entity may use collision information provided by the UE to dynamically adjust the quantity of resources allocated for the passive IoT communications, which may reduce the likelihood of signal collisions occurring during the passive IoT communications.

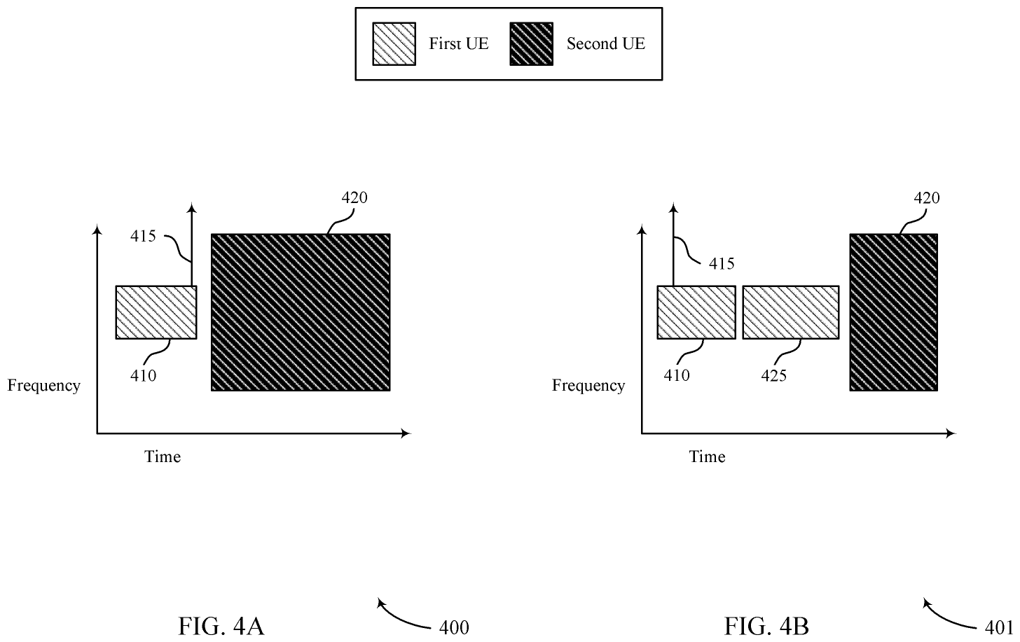

FIGS. 4A and 4B illustrate examples of a resource diagram 400 and a

resource diagram 401 that support techniques for scheduling passive internet of things communications in accordance with one or more aspects of the present disclosure. The resource diagram 400 and the resource diagram 401 may implement or be implemented by aspects of the wireless communications system 100 or the wireless communications system 200. For example, the resource diagram 400 and the resource diagram 401 may be implemented by a UE 115 or a network entity 105 described with reference to FIGS. 1 and 2. As illustrated in the resource diagram 400 and the resource diagram 401, a UE may perform passive IoT communications (e.g., the passive IoT communications 220 described with reference to FIG. 2) on resources allocated by a continuous scheduling grant.

As described with reference to FIGS. 1 through 3, a UE may transmit a passive IoT traffic report prior to initiating passive IoT communications with one or more passive IoT devices. The passive IoT traffic report may function as a scheduling request for the passive IoT communications, and may include information that enables a network entity to allocate an appropriate quantity of resources for the passive IoT communications. For example, the passive IoT traffic report may indicate a quantity of passive IoT devices participating in the passive IoT communications. If, for example, the UE intends to communicate with an unknown quantity of passive IoT devices, the UE may include a default value in the passive IoT traffic report. Accordingly, the network entity may allocate a default quantity of resources for the passive IoT communications.

If the UE determines that the resources provided by the network entity are insufficient for the passive IoT communications, the UE may request additional resources from the network entity. In contrast, if some of the resources provided by the network entity are unused, the UE may transmit an indication of the unused resources to the network entity (such that the network entity can allocate the unused resources to other communication devices). In some examples, the UE may also provide the network entity with collision information related to the passive IoT communications. The network entity may use this information to dynamically adjust the quantity or duration of resources allocated for the passive IoT communications. The described techniques may enable low-cost devices to perform passive IoT communications with greater efficiency.

In the example of FIG. 4A, the UE (e.g., a first UE) may attempt to perform passive IoT communications with one or more passive IoT devices using resources 410 allocated by the network entity. In some cases, a quantity or duration of the resources 410 may be insufficient for the passive IoT communications. In such cases, the UE may transmit a request for a continuous scheduling grant (e.g., a persistent resource allocation) to the network entity at 415. In some cases, however, the UE may be unable to apply the continuous scheduling grant if the UE transmits the request after a specified time. For example, there may be a threshold (e.g., preconfigured) time duration between when the UE transmits the request for the continuous scheduling grant and when the UE can use resources allocated by the continuous scheduling grant. Thus, if the UE transmits the request within this threshold time duration (e.g., if there is not enough time between transmission of the request and a start of the continuous scheduling grant), the UE may be unable to use the continuous scheduling grant for the passive IoT communications.

In the example of FIG. 4B, the UE may transmit a request for a continuous scheduling grant at 415. The UE may transmit the request in response to determining that a duration of the resources 410 (e.g., an initial resource allocation) is insufficient for the passive IoT communications. If the UE transmits the request early enough, the network entity may have sufficient time to process the request and reserve resources 425 (e.g., supplemental resources) for the UE. In other words, the UE can utilize the resources 425 for the passive IoT communications as long as a time duration between transmission of the request and a start of the resources 425 satisfies (e.g., exceeds) a threshold value. Accordingly, the UE may perform the passive IoT communications on the resources 425 in accordance with the continuous scheduling grant. In some examples, the network entity may reserve the resources 425 for the UE by re-allocating the resources 420 that were previously allocated to a second UE.

Aspects of the resource diagram 400 and the resource diagram 401 may be implemented to realize one or more of the following advantages. The techniques and operations described with reference to FIGS. 4A and 4B may enable a network entity to schedule passive IoT communications with reduced communication resource overhead. For example, configuring a UE to transmit a passive IoT traffic report to the network entity in accordance with the techniques described herein may enable the network entity to allocate a suitable quantity of resources for the passive IoT communications. Moreover, if the UE determines that there are insufficient resources allocated for the passive IoT communications, the network entity may allocate additional resources to the UE via a continuous scheduling grant.

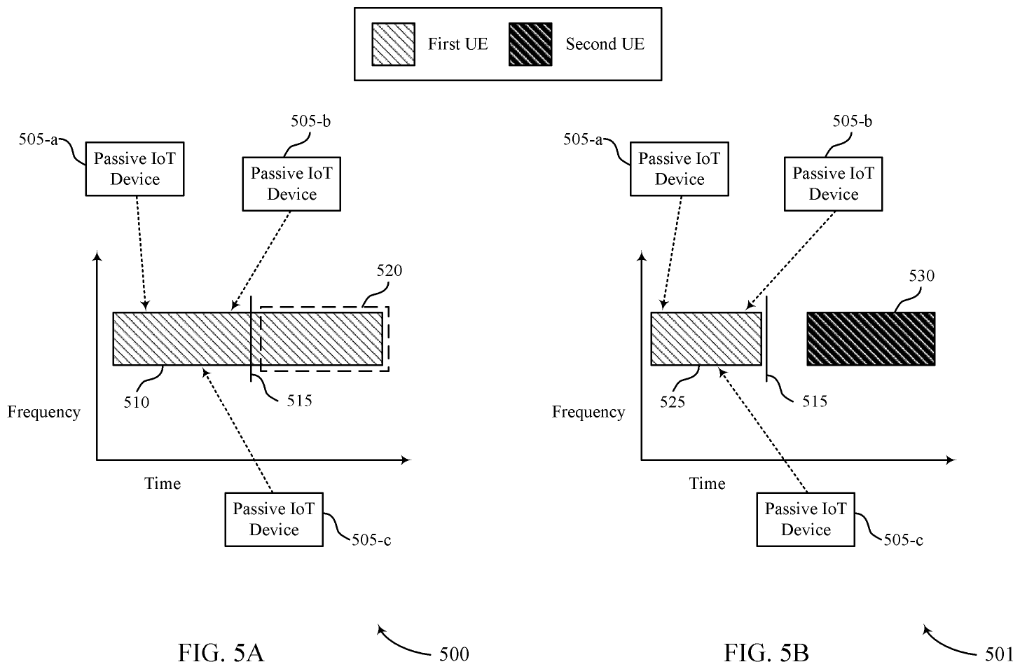

FIGS. 5A and 5B illustrate examples of a resource diagram 500 and a resource diagram 501 that support techniques for scheduling passive IoT communications in accordance with one or more aspects of the present disclosure. The resource diagram 500 and the resource diagram 501 may implement or be implemented by aspects of the wireless communications system 100 or the wireless communications system 200. For example, the resource diagram 500 and the resource diagram 501 may be implemented by a UE 115 or a network entity 105 described with reference to FIGS. 1 and 2. The resource diagram 500 and the resource diagram 501 may include a passive IoT device 505-a, a passive IoT device 505-b, and a passive IoT device 505-c, which may be examples of passive IoT devices 205 or passive IoT devices 305 described with reference to FIGS. 2 and 3. The resource diagram 500 and the resource diagram 501 may support techniques for reducing the communication resource overhead associated with passive IoT communications between a UE and the passive IoT devices 505.

As described with reference to FIGS. 1 through 4, a UE may transmit a passive IoT traffic report (e.g., the passive IoT traffic report 210 described with reference to FIG. 2) prior to initiating passive IoT communications with the passive IoT devices 505. The passive IoT traffic report may function as a scheduling request for the passive IoT communications, and may include information that enables a network entity to allocate an appropriate quantity of resources for the passive IoT communications. For example, the passive IoT traffic report may indicate a quantity of passive IoT devices 505 participating in the passive IoT communications. If, for example, the UE intends to communicate with an unknown quantity of passive IoT devices 505, the UE may include a default value in the passive IoT traffic report. Accordingly, the network entity may allocate a default quantity of resources for the passive IoT communications.

If the UE determines that the resources provided by the network entity are insufficient for the passive IoT communications, the UE may request additional resources from the network entity. In contrast, if some of the resources provided by the network entity are unused, the UE may transmit an indication of the unused resources to the network entity (such that the network entity can allocate the unused resources to other communication devices). In some examples, the UE may also provide the network entity with collision information related to the passive IoT communications. The network entity may use this information to dynamically adjust the quantity or duration of resources allocated for the passive IoT communications. The described techniques may enable low-cost devices to perform passive IoT communications with greater efficiency.

In the example of FIG. 5A, the UE may perform passive IoT communications with the passive IoT devices 505 using resources 510 allocated by the network entity. In some examples, however, the resources 510 may include extraneous (e.g., too many) resources. This may occur when the UE initiates passive IoT communications with an unknown number of passive IoT devices 505 (e.g., when the network entity allocates a default quantity of resources to the UE). In such examples, the UE may determine that the passive IoT communications are complete at 515. As a result, resources 520 may be unused for the passive IoT communications between the UE and the passive IoT devices 505.

In the example of FIG. 5B, the UE may perform the passive IoT communications with the passive IoT devices 505 using resources 525. If, for example, the UE determines that the passive IoT communications are complete at 515, the UE may transmit an indication of any unused resources to the network entity such that the network entity can re-allocate (e.g., recycle) these resources to other communication devices. For example, if the initial set of resources allocated to the UE included resources 530, the UE may transmit an indication of the resources 530 to the network entity upon completion of the passive IoT communications. Accordingly, the network entity may allocate the resources 530 to a second UE, thereby decreasing the communication resource overhead associated with the passive IoT communications between the UE and the passive IoT devices 505.

Aspects of the resource diagram 500 and the resource diagram 501 may be implemented to realize one or more of the following advantages. The techniques and operations described with reference to FIGS. 5A and 5B may enable a network entity to schedule passive IoT communications with reduced communication resource overhead. For example, configuring a UE to transmit a passive IoT traffic report to the network entity in accordance with the techniques described herein may enable the network entity to allocate a suitable quantity of resources for the passive IoT communications. Moreover, the described techniques may enable the passive IoT devices 505 to perform the passive IoT communications with fewer collisions and greater reliability. For example, the network entity may use collision information provided by the UE to dynamically adjust the quantity of resources allocated for the passive IoT communications, which may reduce the likelihood of signal collisions occurring during the passive IoT communications.

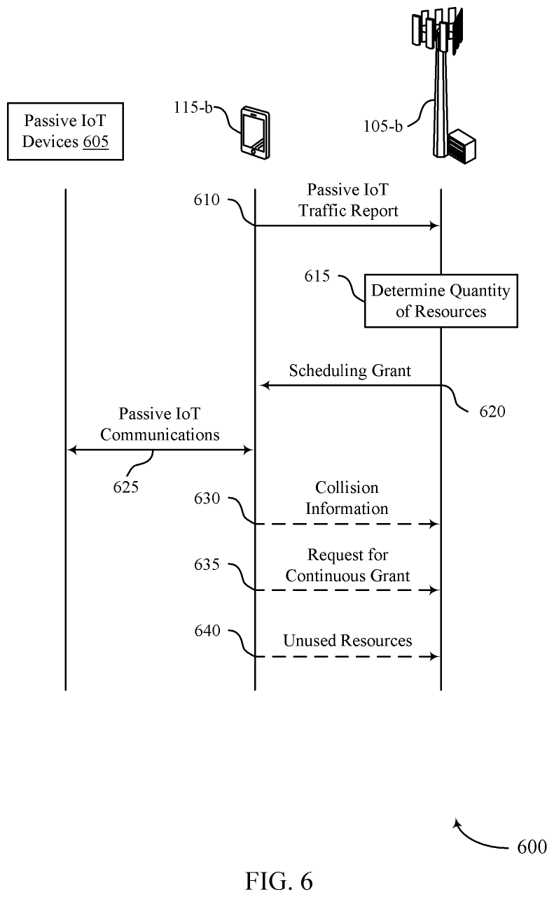

FIG. 6 illustrates an example of a process flow 600 that supports techniques for scheduling passive IoT communications in accordance with one or more aspects of the present disclosure. The process flow 600 may implement or be implemented by aspects of the wireless communications system 100 or the wireless communications system 200. For example, the process flow 600 may include a UE 115-b and a network entity 105-b, which may be examples of corresponding devices described with reference to FIGS. 1 and 2. The process flow 600 may also include passive IoT devices 605, which may be examples of corresponding devices described with reference to FIGS. 2, 3, and 5. In the following description of the process flow 600, operations between the UE 115-b, the network entity 105-b, and the passive IoT devices 605 may be performed in a different order or at different times. Additionally or alternatively, some operations may be omitted from the process flow 600 and other operations may be added to the process flow 600.

At 610, the UE 115-b may transmit a passive IoT traffic report (also referred to herein as a passive IoT scheduling request) to the network entity 105-b. The passive IoT traffic report may be different from uplink scheduling requests (e.g. requests for uplink resources) and sidelink scheduling requests (e.g., requests for sidelink resources). The passive IoT traffic report may indicate one or more passive IoT communications to be performed between the UE 115-b and the passive IoT devices 605. In some examples, the passive IoT traffic report may indicate a quantity of the passive IoT devices 605. In other examples, the passive IoT traffic report may indicate a default value corresponding to an unknown quantity of the passive IoT devices 605.

Additionally or alternatively, the passive IoT traffic report may indicate a cast type (also referred to herein as a traffic type) associated with the passive IoT communications. For example, the passive IoT traffic report may indicate a broadcast type, a unicast type, or a groupcast type associated with the passive IoT communications. In such examples, the network entity 105-b may implicitly determine (e.g., infer) the quantity of passive IoT devices 605 based on the cast type indicated in the passive IoT traffic report. If, for example, the passive IoT traffic report indicates that the passive IoT communications are associated with a broadcast type, the network entity 105-b may determine that the UE 115-b intends to perform the passive IoT communications with an unknown quantity of passive IoT devices 605.

Alternatively, if the passive IoT traffic report indicates that the passive IoT communications are associated with a unicast type, the network entity 105-b may determine that the UE 115-b intends to perform the passive IoT communications with a single passive IoT device (e.g., one of the passive IoT devices 605). Likewise, the network entity 105-b may determine that the UE 115-b intends to perform the passive IoT communications with a specific quantity of passive IoT devices 605 if the passive IoT traffic report indicates a groupcast type associated with the passive IoT communications. Thus, the network entity 105-b may implicitly determine the quantity of passive IoT devices 605 that will be participating in the passive IoT communications, even if such information is not explicitly signaled in the passive IoT traffic report.

At 615, the network entity 105-b may determine a quantity of resources to allocate for the passive IoT communications between the UE 115-b and the passive IoT devices 605. If, for example, the passive IoT traffic report indicates a quantity of the passive IoT devices 605, the network entity 105-b may allocate resources to the UE 115-b based on the indicated quantity. Alternatively, if the passive IoT traffic report indicates a default value for the quantity of passive IoT devices 605, the network entity 105-b may allocate a default quantity of resources to the UE 115-b. At 620, the UE 115-b may receive a scheduling grant from the network entity 105-b. The scheduling grant may indicate a set of time and frequency resources allocated for the passive IoT communications between the UE 115-b and the passive IoT devices 605. At 625, the UE 115-b may perform the passive IoT communications with the passive IoT devices 605 using the set of time and frequency resources allocated by the scheduling grant.

In some examples, the UE 115-b may transmit collision information to the network entity 105-b at 630. The collision information may indicate a probability (e.g., likelihood) of collisions occurring during the passive IoT communications, a probability that the set of time and frequency resources includes unused slots (e.g., time resources), or both. Additionally or alternatively, the UE 115-b may transmit an indication of an expected time duration for the set of passive IoT communications to the network entity 105-b. The network entity 105-b may use this information to update (e.g., adjust) the quantity or duration of resources allocated for the passive IoT communications. For example, the network entity 105-b may transmit (e.g., output) a second scheduling grant that indicates a second set of time and frequency resources (e.g., supplemental resources) allocated for the passive IoT communications.

If, for example, the UE 115-b determines that the time and frequency resources allocated by the network entity 105-b are insufficient for the passive IoT communications, the UE 115-b may transmit a request for a continuous scheduling grant (e.g., a persistent resource allocation) to the network entity 105-b at 635. Accordingly, the UE 115-b may perform (e.g., continue) the passive IoT communications on resources allocated by the continuous scheduling grant. Alternatively, if the UE 115-b determines that the time and frequency resources allocated by the network entity 105-b include unused resources, the UE 115-b may transmit an indication of the unused resources to the network entity 105-b at 640 (e.g., upon completion of the passive IoT communications). In some examples, the network entity 105-b may allocate these unused resources to other communication devices, thereby reducing the communication resource overhead associated with the passive IoT communications.

Aspects of the process flow 600 may be implemented to realize one or more of the following advantages. The techniques and operations described with reference to FIG. 6 may enable the network entity 105-b to schedule passive IoT communications with reduced communication resource overhead. For example, configuring the UE 115-b to transmit a passive IoT traffic report to the network entity 105-b in accordance with the techniques described herein may enable the network entity 105-b to allocate a suitable quantity of resources for the passive IoT communications. Moreover, the described techniques may enable the UE 115-b to perform the passive IoT communications with fewer collisions and greater reliability. For example, the network entity 105-b may use collision information provided by the UE 115-b to dynamically adjust the quantity of resources allocated for the passive IoT communications, which may reduce the likelihood of signal collisions occurring during the passive IoT communications.

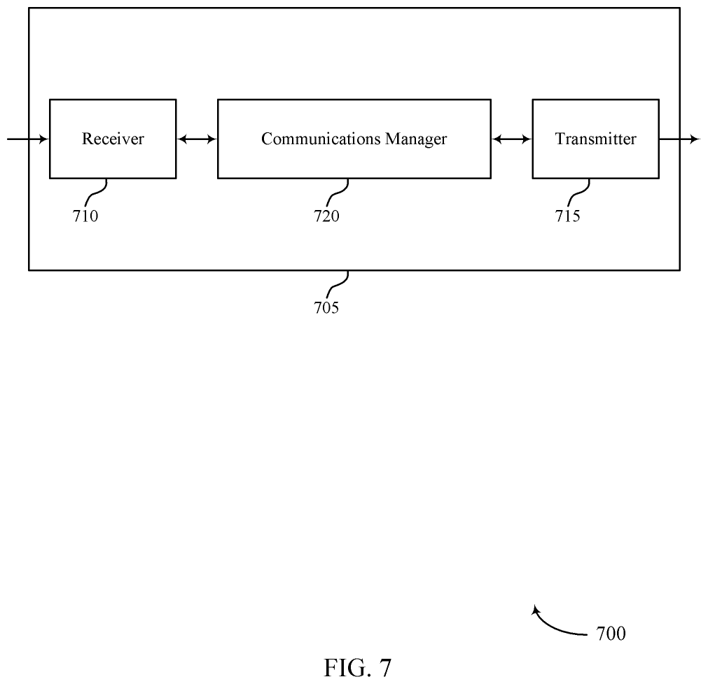

FIG. 7 shows a block diagram 700 of a device 705 that supports techniques for scheduling passive IoT communications in accordance with one or more aspects of the present disclosure. The device 705 may be an example of aspects of a UE 115, as described herein. The device 705 may include a receiver 710, a transmitter 715, and a communications manager 720. The device 705 may also include at least one processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for scheduling passive IoT communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for scheduling passive IoT communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for scheduling passive IoT communications, as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include at least one processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled (e.g., operatively, communicatively, functionally, electronically, or electrically) with the at least one processor may be configured to perform one or more of the functions described herein (e.g., by executing instructions stored in the memory)

Additionally, or alternatively, in some examples, the communications manager 720, the receiver 710, the transmitter 715, or various combinations or components thereof may be implemented in hardware, software (e.g., executed by at least one processor), or any combination thereof. If implemented in code executed by at least one processor, the functions of the communications manager 720, the receiver 710, the transmitter 715, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations, as described herein.

The communications manager 720 may support wireless communication at the device 705 in accordance with examples disclosed herein. For example, the communications manager 720 may be configured as or otherwise support a means for outputting a passive IoT traffic report to the transmitter 715 for transmission by the device 705. The passive IoT traffic report may indicate a set of passive IoT communications to be performed between the device 705 and one or more passive IoT devices. The communications manager 720 may be configured as or otherwise support a means for obtaining a scheduling grant from the receiver 710 based on the passive IoT traffic report. The scheduling grant may indicate a set of time and frequency resources allocated for the set of passive IoT communications between the device 705 and the one or more passive IoT devices. The communications manager 720 may be configured as or otherwise support a means for performing the set of passive IoT communications with the one or more passive IoT devices using the set of time and frequency resources indicated by the scheduling grant.

By including or configuring the communications manager 720 in accordance with examples, as described herein, the device 705 (e.g., at least one processor controlling or otherwise coupled with the receiver 710, the transmitter 715, the communications manager 720, or a combination thereof) may support techniques for more efficient utilization of communication resources. For example, by configuring the device 705 to transmit a passive IoT traffic report to a network entity in accordance with the techniques described herein, the network entity may allocate a suitable quantity of resources for the passive IoT communications, which may reduce the communication resource overhead associated with the passive IoT communications.

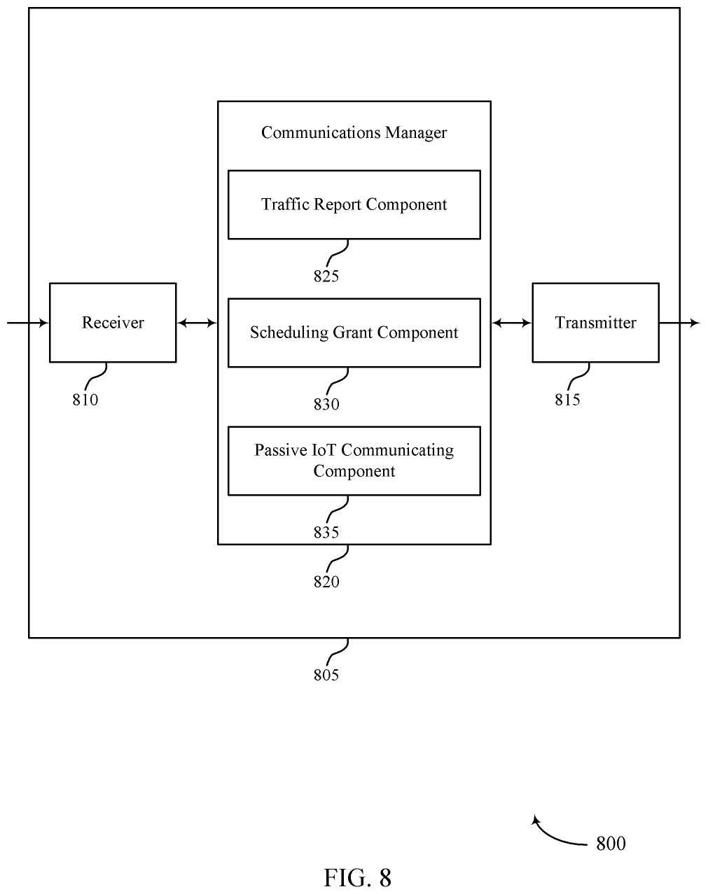

FIG. 8 shows a block diagram 800 of a device 805 that supports techniques for scheduling passive IoT communications in accordance with one or more aspects of the present disclosure. The device 805 may be an example of aspects of a device 705 or a UE 115, as described herein. The device 805 may include a receiver 810, a transmitter 815, and a communications manager 820. The device 805 may also include at least one processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for scheduling passive IoT communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for scheduling passive IoT communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for scheduling passive IoT communications, as described herein. For example, the communications manager 820 may include a traffic report component 825, a scheduling grant component 830, a passive IoT communicating component 835, or any combination thereof. The communications manager 820 may be an example of aspects of a communications manager 720, as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations, as described herein.

The communications manager 820 may support wireless communication at the device 805 in accordance with examples disclosed herein. The traffic report component 825 may be configured as or otherwise support a means for outputting a passive IoT traffic report to the transmitter 815 for transmission by the device 805. The passive IoT traffic report may indicate a set of passive IoT communications to be performed between the device 805 and one or more passive IoT devices. The scheduling grant component 830 may be configured as or otherwise support a means for obtaining a scheduling grant from the receiver 810 based on the passive IoT traffic report. The scheduling grant may indicate a set of time and frequency resources allocated for the set of passive IoT communications between the device 805 and the one or more passive IoT devices. The passive IoT communicating component 835 may be configured as or otherwise support a means for performing the set of passive IoT communications with the one or more passive IoT devices using the set of time and frequency resources indicated by the scheduling grant.

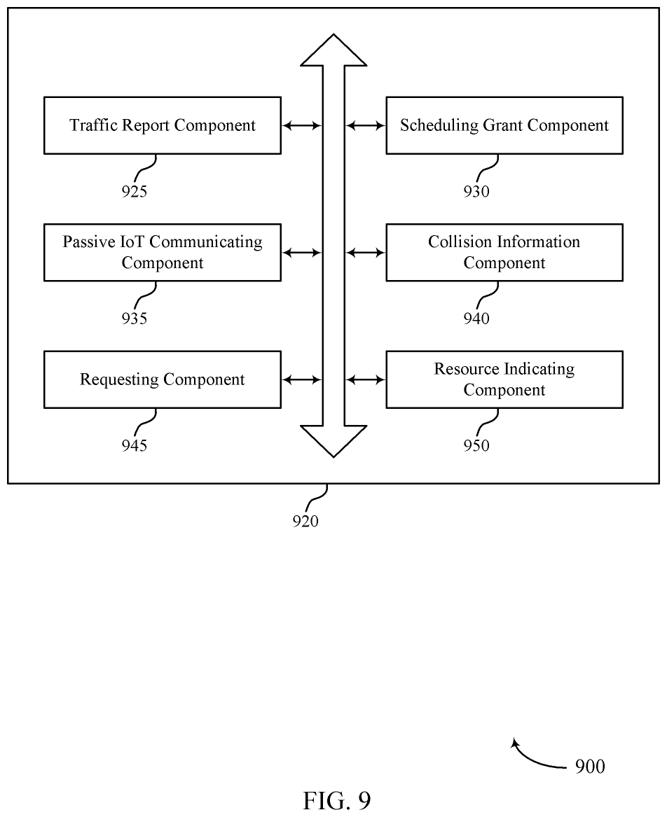

FIG. 9 shows a block diagram 900 of a communications manager 920 that supports techniques for scheduling passive IoT communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for scheduling passive IoT communications, as described herein. For example, the communications manager 920 may include a traffic report component 925, a scheduling grant component 930, a passive IoT communicating component 935, a collision information component 940, a requesting component 945, a resource indicating component 950, or any combination thereof. Each of these components may communicate, directly or indirectly, with one another (e.g., via one or more buses).

The communications manager 920 may support wireless communication at a UE in accordance with examples disclosed herein. The traffic report component 925 may be configured as or otherwise support a means for transmitting a passive IoT traffic report that indicates a set of passive IoT communications to be performed between the UE and one or more passive IoT devices. The scheduling grant component 930 may be configured as or otherwise support a means for receiving, based on the passive IoT traffic report, a scheduling grant that indicates a set of time and frequency resources allocated for the set of passive IoT communications between the UE and the one or more passive IoT devices. The passive IoT communicating component 935 may be configured as or otherwise support a means for performing the set of passive IoT communications with the one or more passive IoT devices using the set of time and frequency resources indicated by the scheduling grant.

In some examples, to support transmitting the passive IoT traffic report, the traffic report component 925 may be configured as or otherwise support a means for signaling a quantity of the one or more passive IoT devices in the passive IoT traffic report. In some examples, a quantity of resources in the set of time and frequency resources indicated by the scheduling grant corresponds to the quantity of the one or more passive IoT devices signaled by the passive IoT traffic report.

In some examples, to support transmitting the passive IoT traffic report, the traffic report component 925 may be configured as or otherwise support a means for signaling a default value corresponding to an unknown quantity of the one or more passive IoT devices in the passive IoT traffic report. In some examples, a quantity of resources in the set of time and frequency resources indicated by the scheduling grant corresponds to the default value signaled by the passive IoT traffic report.

In some examples, to support transmitting the passive IoT traffic report, the traffic report component 925 may be configured as or otherwise support a means for signaling a cast type associated with the set of passive IoT communications in the passive IoT traffic report, where the cast type includes one or more of a broadcast type, a unicast type, or a groupcast type. In some examples, the cast type signaled in the passive IoT traffic report indicates a quantity of the one or more passive IoT devices.

In some examples, the collision information component 940 may be configured as or otherwise support a means for transmitting a message that indicates collision information associated with the set of passive IoT communications, an estimated time duration of the set of passive IoT communications, or both. In some examples, the collision information indicates a probability of collisions occurring during the set of passive IoT communications, a probability of the set of time and frequency resources including unused slots, or both.

In some examples, the scheduling grant component 930 may be configured as or otherwise support a means for receiving, based on the message, a second scheduling grant that indicates a second set of time and frequency resources allocated for the set of passive IoT communications.

In some examples, the requesting component 945 may be configured as or otherwise support a means for transmitting a request for a second scheduling grant based on a quantity of the one or more passive IoT devices, an estimated time duration of the set of passive IoT communications, a quantity of resources allocated by the scheduling grant, a time duration of resources allocated by the scheduling grant, or a combination thereof. In some examples, the scheduling grant component 930 may be configured as or otherwise support a means for receiving the second scheduling grant based on a time duration between transmission of the request and a start of the second scheduling grant satisfying a threshold, where the second scheduling grant indicates a second set of time and frequency resources allocated for the set of passive IoT communications.

In some examples, the scheduling grant component 930 may be configured as or otherwise support a means for transmitting a request for a continuous scheduling grant within a time duration of the set of time and frequency resources. In some examples, the passive IoT communicating component 935 may be configured as or otherwise support a means for performing the set of passive IoT communications using a second set of time and frequency resources in accordance with the continuous scheduling grant.

In some examples, the resource indicating component 950 may be configured as or otherwise support a means for transmitting an indication of at least one unused time or frequency resource upon completion of the set of passive IoT communications.

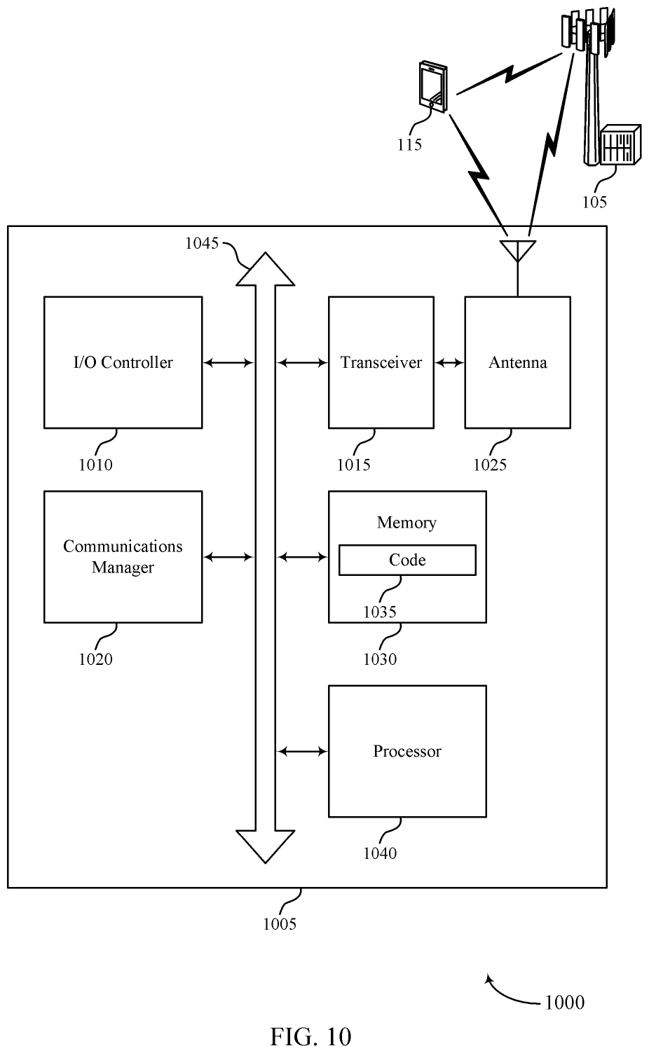

FIG. 10 shows a diagram of a system 1000 including a device 1005 that supports techniques for scheduling passive IoT communications in accordance with one or more aspects of the present disclosure. The device 1005 may be an example of or include the components of a device 705, a device 805, or a UE 115, as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links, as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for scheduling passive IoT communications). For example, the device 1005 or a component of the device 1005 may include a processor 1040 and memory 1030 coupled (e.g., operatively, communicatively, functionally, electronically, or electrically) with or to the processor 1040, the processor 1040 and memory 1030 configured to perform various functions described herein.

The communications manager 1020 may support wireless communication at the device 1005 in accordance with examples disclosed herein. For example, the communications manager 1020 may be configured as or otherwise support a means for transmitting a passive IoT traffic report that indicates a set of passive IoT communications to be performed between the UE and one or more passive IoT devices. The communications manager 1020 may be configured as or otherwise support a means for receiving, based on the passive IoT traffic report, a scheduling grant that indicates a set of time and frequency resources allocated for the set of passive IoT communications between the UE and the one or more passive IoT devices. The communications manager 1020 may be configured as or otherwise support a means for performing the set of passive IoT communications with the one or more passive IoT devices using the set of time and frequency resources indicated by the scheduling grant.

By including or configuring the communications manager 1020 in accordance with examples, as described herein, the device 1005 may support techniques for improved communication reliability. For example, by configuring the device 1005 to transmit collision information to a network entity in accordance with the techniques described herein, the network entity may use the collision information provided by the device 1005 to dynamically adjust a quantity or duration of resources allocated for passive IoT communications between the device 1005 and one or more passive IoT devices, which may reduce the likelihood of signal collisions occurring during the passive IoT communications.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for scheduling passive IoT communications, as described herein, or the processor 1040 and the memory 1030 may be otherwise configured to perform or support such operations.

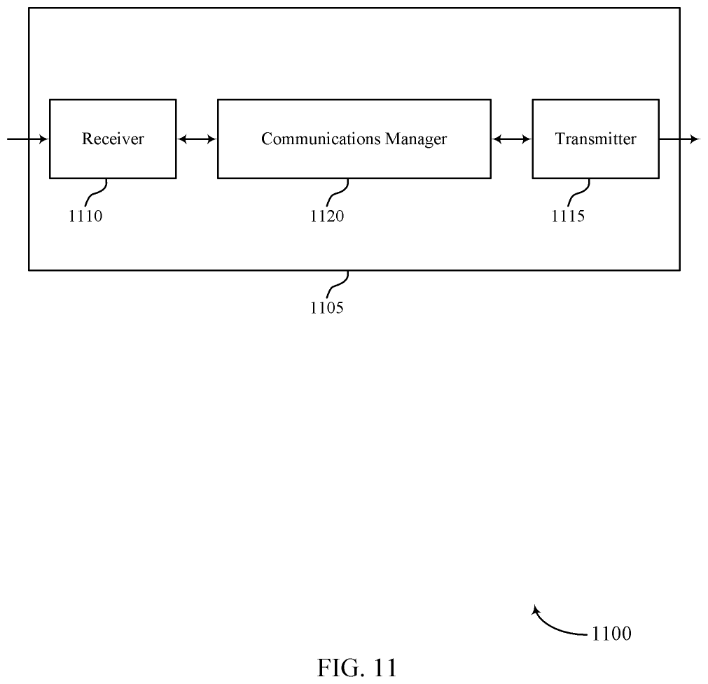

FIG. 11 shows a block diagram 1100 of a device 1105 that supports techniques for scheduling passive IoT communications in accordance with one or more aspects of the present disclosure. The device 1105 may be an example of aspects of a network entity 105, as described herein. The device 1105 may include a receiver 1110, a transmitter 1115, and a communications manager 1120. The device 1105 may also include at least one processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled (e.g., operatively, communicatively, functionally, electronically, or electrically) with a modem.

The communications manager 1120, the receiver 1110, the transmitter 1115, or various combinations thereof or various components thereof may be examples of means for performing various aspects of techniques for scheduling passive IoT communications, as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include at least one processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and memory coupled (e.g., operatively, communicatively, functionally, electronically, or electrically) with the at least one processor may be configured to perform one or more of the functions described herein (e.g., by executing instructions stored in the memory).

Additionally, or alternatively, in some examples, the communications manager 1120, the receiver 1110, the transmitter 1115, or various combinations or components thereof may be implemented in hardware, software (e.g., executed by at least one processor), or any combination thereof. If implemented in code executed by at least one processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations, as described herein.

The communications manager 1120 may support wireless communication at the device 1105 in accordance with examples disclosed herein. For example, the communications manager 1120 may be configured as or otherwise support a means for obtaining a passive IoT traffic report from the receiver 1110. The passive IoT traffic report may indicate a set of passive IoT communications to be performed between a UE and one or more passive IoT devices. The communications manager 1120 may be configured as or otherwise support a means for determining a set of time and frequency resources to allocate for the set of passive IoT communications between the UE and the one or more passive IoT devices based on the passive IoT traffic report. The communications manager 1120 may be configured as or otherwise support a means for outputting a scheduling grant to the transmitter 1115 for transmission by the device 1105. The scheduling grant may indicate the set of time and frequency resources allocated for the set of passive IoT communications between the UE and the one or more passive IoT devices.

By including or configuring the communications manager 1120 in accordance with examples, as described herein, the device 1105 (e.g., at least one processor controlling or otherwise coupled with the receiver 1110, the transmitter 1115, the communications manager 1120, or a combination thereof) may support techniques for more efficient utilization of communication resources. For example, the device 1105 may use a passive IoT traffic report provided by a UE to determine an appropriate resource allocation for passive IoT communications between the UE and one or more passive IoT devices, which may reduce the communication resource overhead associated with the passive IoT communications.

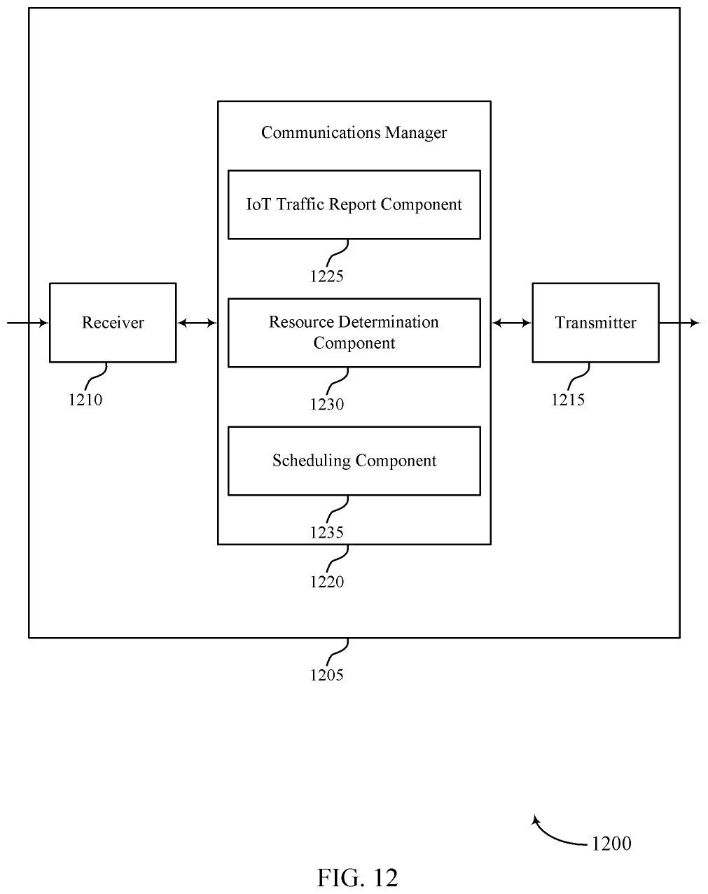

FIG. 12 shows a block diagram 1200 of a device 1205 that supports techniques for scheduling passive IoT communications in accordance with one or more aspects of the present disclosure. The device 1205 may be an example of aspects of a device 1105 or a network entity 105, as described herein. The device 1205 may include a receiver 1210, a transmitter 1215, and a communications manager 1220. The device 1205 may also include at least one processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled (e.g., operatively, communicatively, functionally, electronically, or electrically) with a modem.

The device 1205, or various components thereof, may be an example of means for performing various aspects of techniques for scheduling passive IoT communications, as described herein. For example, the communications manager 1220 may include an IoT traffic report component 1225, a resource determination component 1230, a scheduling component 1235, or any combination thereof. The communications manager 1220 may be an example of aspects of a communications manager 1120, as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations, as described herein.

The communications manager 1220 may support wireless communication at the device 1205 in accordance with examples disclosed herein. The IoT traffic report component 1225 may be configured as or otherwise support a means for obtaining a passive IoT traffic report from the receiver 1210. The passive IoT traffic report may indicate a set of passive IoT communications to be performed between a UE and one or more passive IoT devices. The resource determination component 1230 may be configured as or otherwise support a means for determining a set of time and frequency resources to allocate for the set of passive IoT communications between the UE and the one or more passive IoT devices based on the passive IoT traffic report. The scheduling component 1235 may be configured as or otherwise support a means for outputting a scheduling grant to the transmitter 1215 for transmission by the device 1205. The scheduling grant may indicate the set of time and frequency resources allocated for the set of passive IoT communications between the UE and the one or more passive IoT devices.

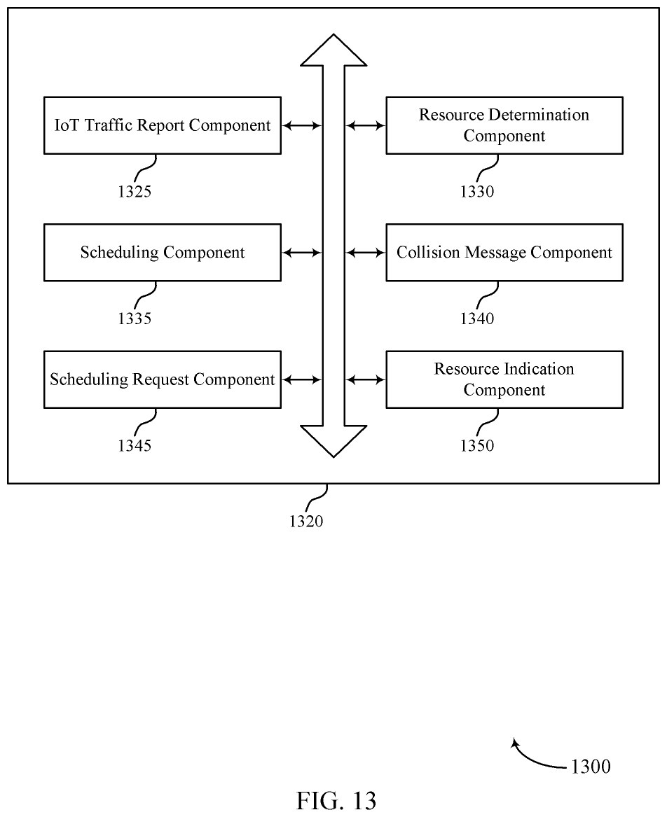

FIG. 13 shows a block diagram 1300 of a communications manager 1320 that supports techniques for scheduling passive IoT communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for scheduling passive IoT communications, as described herein. For example, the communications manager 1320 may include an IoT traffic report component 1325, a resource determination component 1330, a scheduling component 1335, a collision message component 1340, a scheduling request component 1345, a resource indication component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples disclosed herein. The IoT traffic report component 1325 may be configured as or otherwise support a means for obtaining a passive IoT traffic report that indicates a set of passive IoT communications to be performed between a UE and one or more passive IoT devices. The resource determination component 1330 may be configured as or otherwise support a means for determining a set of time and frequency resources to allocate for the set of passive IoT communications between the UE and the one or more passive IoT devices based on the passive IoT traffic report. The scheduling component 1335 may be configured as or otherwise support a means for outputting a scheduling grant that indicates the set of time and frequency resources allocated for the set of passive IoT communications between the UE and the one or more passive IoT devices.

In some examples, the passive IoT traffic report signals a quantity of the one or more passive IoT devices. In some examples, to support determining the set of time and frequency resources, the resource determination component 1330 may be configured as or otherwise support a means for determining a quantity of resources to include in the set of time and frequency resources based on the quantity of the one or more passive IoT devices signaled by the passive IoT traffic report.

In some examples, the passive IoT traffic report signals a default value corresponding to an unknown quantity of the one or more passive IoT devices. In some examples, to support determining the set of time and frequency resources, the resource determination component 1330 may be configured as or otherwise support a means for determining a quantity of resources to include in the set of time and frequency resources based on the default value signaled by the passive IoT traffic report.

In some examples, the passive IoT traffic report signals a cast type associated with the set of passive IoT communications, where the cast type includes one or more of a broadcast type, a unicast type, or a groupcast type. In some examples, the resource determination component 1330 may be configured as or otherwise support a means for determining a quantity of the one or more passive IoT devices based on the cast type signaled in the passive IoT traffic report.

In some examples, the collision message component 1340 may be configured as or otherwise support a means for obtaining a message that indicates collision information associated with the set of passive IoT communications, an estimated time duration of the set of passive IoT communications, or both. In some examples, the collision information indicates a probability of collisions occurring during the set of passive IoT communications, a probability of the set of time and frequency resources including unused slots, or both.

In some examples, the scheduling component 1335 may be configured as or otherwise support a means for outputting a second scheduling grant that indicates a second set of time and frequency resources allocated for the set of passive IoT communications based on the message.

In some examples, the scheduling request component 1345 may be configured as or otherwise support a means for obtaining a request for a continuous scheduling grant within a time duration of the set of time and frequency resources. In some examples, the resource determination component 1330 may be configured as or otherwise support a means for allocating a second set of time and frequency resources for the set of passive IoT communications in accordance with the continuous scheduling grant.

In some examples, the resource indication component 1350 may be configured as or otherwise support a means for receiving an indication of at least one unused time or frequency resource in the set of time and frequency resources allocated for the set of passive IoT communications. In some examples, the resource determination component 1330 may be configured as or otherwise support a means for allocating the at least one unused time or frequency resource to a second UE that is different from the UE.

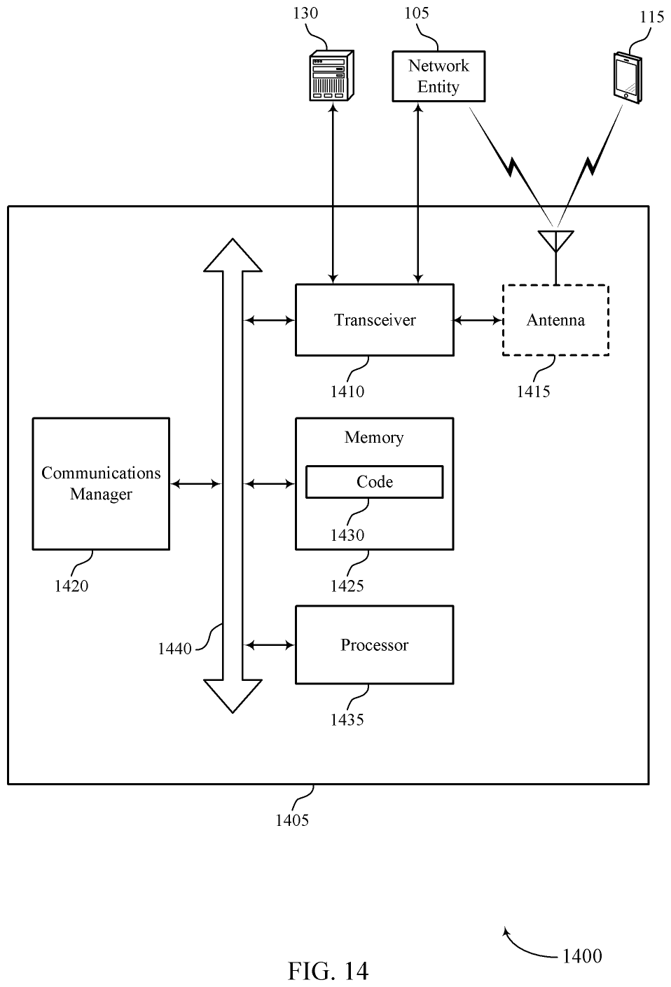

FIG. 14 shows a diagram of a system 1400 including a device 1405 that supports techniques for scheduling passive IoT communications in accordance with one or more aspects of the present disclosure. The device 1405 may be an example of or include the components of a device 1105, a device 1205, or a network entity 105, as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both, as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for scheduling passive IoT communications). For example, the device 1405 or a component of the device 1405 may include a processor 1435 and memory 1425 coupled (e.g., operatively, communicatively, functionally, electronically, or electrically) with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at the device 1405 in accordance with examples disclosed herein. For example, the communications manager 1420 may be configured as or otherwise support a means for obtaining a passive IoT traffic report that indicates a set of passive IoT communications to be performed between a UE and one or more passive IoT devices. The communications manager 1420 may be configured as or otherwise support a means for determining a set of time and frequency resources to allocate for the set of passive IoT communications between the UE and the one or more passive IoT devices based on the passive IoT traffic report. The communications manager 1420 may be configured as or otherwise support a means for outputting a scheduling grant that indicates the set of time and frequency resources allocated for the set of passive IoT communications between the UE and the one or more passive IoT devices.

By including or configuring the communications manager 1420 in accordance with examples, as described herein, the device 1405 may support techniques for improved communication reliability. For example, the device 1405 may use collision information provided by a UE to dynamically adjust a resource allocation for passive IoT communications between the UE and one or more passive IoT devices, which may reduce the probability of signal collisions occurring throughout the passive IoT communications, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of techniques for scheduling passive IoT communications, as described herein, or the processor 1435 and the memory 1425 may be otherwise configured to perform or support such operations.

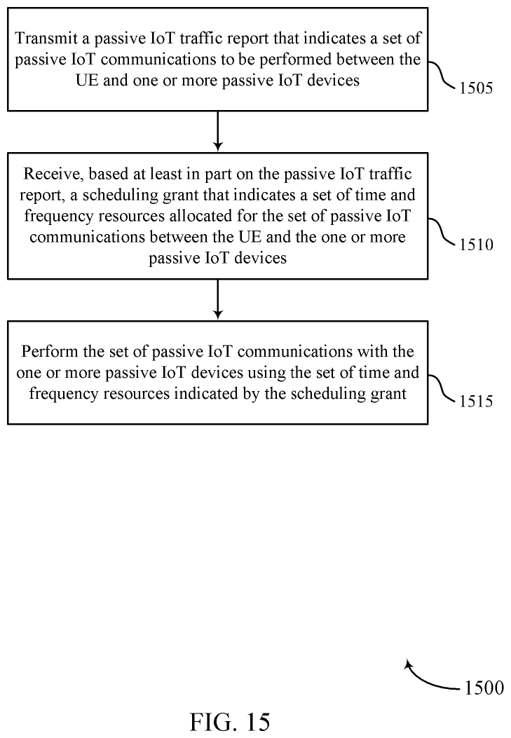

FIG. 15 shows a flowchart illustrating a method 1500 that supports techniques for scheduling passive IoT communications in accordance with one or more aspects of the present disclosure. The operations of the method 1500 may be implemented by a UE or components of a UE, as described herein. For example, the operations of the method 1500 may be performed by a UE 115, as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting a passive IoT traffic report that indicates a set of passive IoT communications to be performed between the UE and one or more passive IoT devices. The operations of 1505 may be performed in accordance with examples disclosed herein. In some examples, aspects of the operations of 1505 may be performed by a traffic report component 925, as described with reference to FIG. 9.

At 1510, the method may include receiving, based at least in part on the passive IoT traffic report, a scheduling grant that indicates a set of time and frequency resources allocated for the set of passive IoT communications between the UE and the one or more passive IoT devices. The operations of 1510 may be performed in accordance with examples disclosed herein. In some examples, aspects of the operations of 1510 may be performed by a scheduling grant component 930, as described with reference to FIG. 9.

At 1515, the method may include performing the set of passive IoT communications with the one or more passive IoT devices using the set of time and frequency resources indicated by the scheduling grant. The operations of 1515 may be performed in accordance with examples disclosed herein. In some examples, aspects of the operations of 1515 may be performed by a passive IoT communicating component 935, as described with reference to FIG. 9.

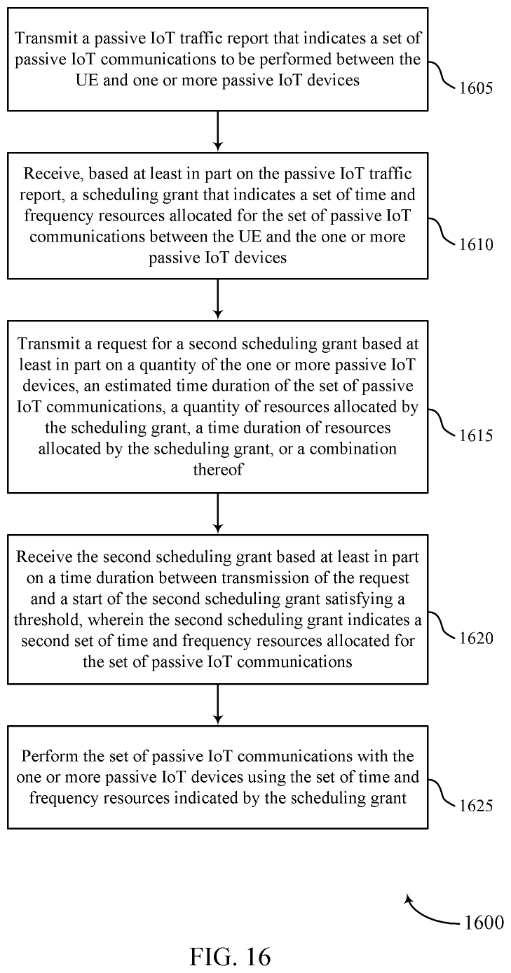

FIG. 16 shows a flowchart illustrating a method 1600 that supports techniques for scheduling passive IoT communications in accordance with one or more aspects of the present disclosure. The operations of the method 1600 may be implemented by a UE or components of a UE, as described herein. For example, the operations of the method 1600 may be performed by a UE 115, as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a passive IoT traffic report that indicates a set of passive IoT communications to be performed between the UE and one or more passive IoT devices. The operations of 1605 may be performed in accordance with examples disclosed herein. In some examples, aspects of the operations of 1605 may be performed by a traffic report component 925, as described with reference to FIG. 9.

At 1610, the method may include receiving, based at least in part on the passive IoT traffic report, a scheduling grant that indicates a set of time and frequency resources allocated for the set of passive IoT communications between the UE and the one or more passive IoT devices. The operations of 1610 may be performed in accordance with examples disclosed herein. In some examples, aspects of the operations of 1610 may be performed by a scheduling grant component 930, as described with reference to FIG. 9.

At 1615, the method may include transmitting a request for a second scheduling grant based at least in part on a quantity of the one or more passive IoT devices, an estimated time duration of the set of passive IoT communications, a quantity of resources allocated by the scheduling grant, a time duration of resources allocated by the scheduling grant, or a combination thereof. The operations of 1615 may be performed in accordance with examples disclosed herein. In some examples, aspects of the operations of 1615 may be performed by a requesting component 945, as described with reference to FIG. 9.

At 1620, the method may include receiving the second scheduling grant based at least in part on a time duration between transmission of the request and a start of the second scheduling grant satisfying a threshold, wherein the second scheduling grant indicates a second set of time and frequency resources allocated for the set of passive IoT communications. The operations of 1620 may be performed in accordance with examples disclosed herein. In some examples, aspects of the operations of 1620 may be performed by a scheduling grant component 930, as described with reference to FIG. 9.

At 1625, the method may include performing the set of passive IoT communications with the one or more passive IoT devices using the set of time and frequency resources indicated by the scheduling grant. The operations of 1625 may be performed in accordance with examples disclosed herein. In some examples, aspects of the operations of 1625 may be performed by a passive IoT communicating component 935, as described with reference to FIG. 9.

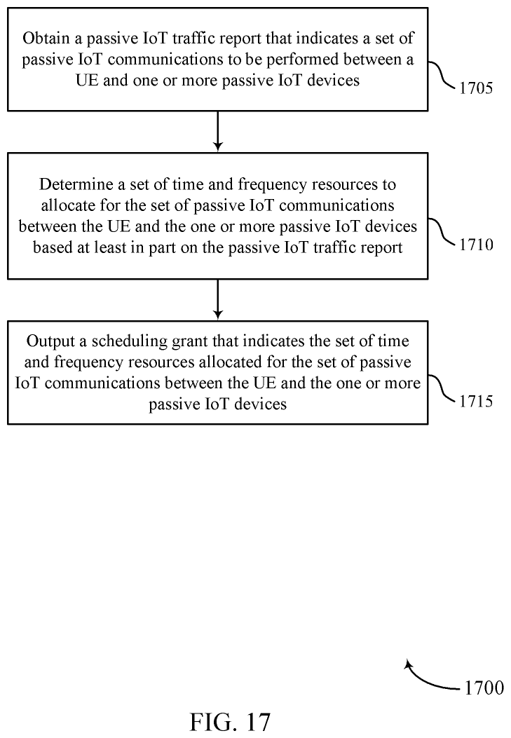

FIG. 17 shows a flowchart illustrating a method 1700 that supports techniques for scheduling passive IoT communications in accordance with one or more aspects of the present disclosure. The operations of the method 1700 may be implemented by a network entity or components of a network entity, as described herein. For example, the operations of the method 1700 may be performed by a network entity, as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include obtaining a passive IoT traffic report that indicates a set of passive IoT communications to be performed between a UE and one or more passive IoT devices. The operations of 1705 may be performed in accordance with examples disclosed herein. In some examples, aspects of the operations of 1705 may be performed by an IoT traffic report component 1325, as described with reference to FIG. 13.

At 1710, the method may include determining a set of time and frequency resources to allocate for the set of passive IoT communications between the UE and the one or more passive IoT devices based at least in part on the passive IoT traffic report. The operations of 1710 may be performed in accordance with examples disclosed herein. In some examples, aspects of the operations of 1710 may be performed by a resource determination component 1330, as described with reference to FIG. 13.

At 1715, the method may include outputting a scheduling grant that indicates the set of time and frequency resources allocated for the set of passive IoT communications between the UE and the one or more passive IoT devices. The operations of 1715 may be performed in accordance with examples disclosed herein. In some examples, aspects of the operations of 1715 may be performed by a scheduling component 1335, as described with reference to FIG. 13.

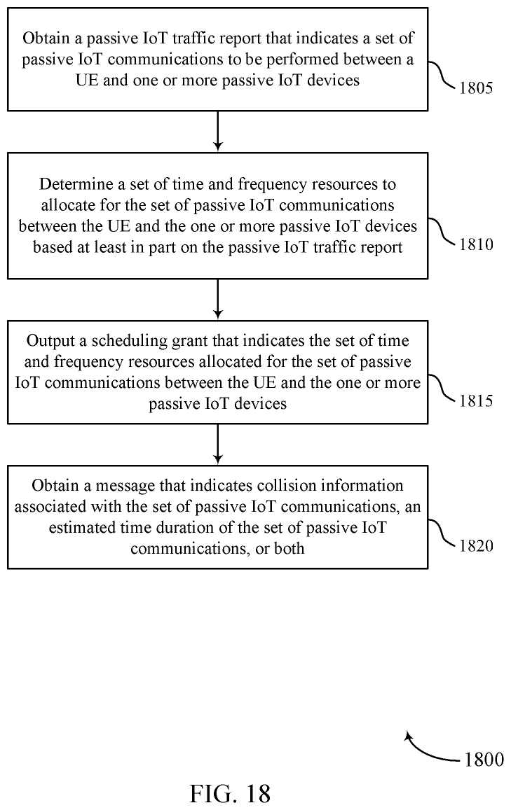

FIG. 18 shows a flowchart illustrating a method 1800 that supports techniques for scheduling passive IoT communications in accordance with one or more aspects of the present disclosure. The operations of the method 1800 may be implemented by a network entity or components of a network entity, as described herein. For example, the operations of the method 1800 may be performed by a network entity, as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include obtaining a passive IoT traffic report that indicates a set of passive IoT communications to be performed between a UE and one or more passive IoT devices. The operations of 1805 may be performed in accordance with examples disclosed herein. In some examples, aspects of the operations of 1805 may be performed by an IoT traffic report component 1325, as described with reference to FIG. 13.

At 1810, the method may include determining a set of time and frequency resources to allocate for the set of passive IoT communications between the UE and the one or more passive IoT devices based at least in part on the passive IoT traffic report. The operations of 1810 may be performed in accordance with examples disclosed herein. In some examples, aspects of the operations of 1810 may be performed by a resource determination component 1330, as described with reference to FIG. 13.

At 1815, the method may include outputting a scheduling grant that indicates the set of time and frequency resources allocated for the set of passive IoT communications between the UE and the one or more passive IoT devices. The operations of 1815 may be performed in accordance with examples disclosed herein. In some examples, aspects of the operations of 1815 may be performed by a scheduling component 1335, as described with reference to FIG. 13.

At 1820, the method may include obtaining a message that indicates collision information associated with the set of passive IoT communications, an estimated time duration of the set of passive IoT communications, or both. The operations of 1820 may be performed in accordance with examples disclosed herein. In some examples, aspects of the operations of 1820 may be performed by a collision message component 1340, as described with reference to FIG. 13.

The following provides an overview of aspects of the present disclosure:

Aspect 1: A method for wireless communication at a UE, comprising: transmitting a passive IoT traffic report that indicates a set of passive IoT communications to be performed between the UE and one or more passive IoT devices; receiving, based at least in part on the passive IoT traffic report, a scheduling grant that indicates a set of time and frequency resources allocated for the set of passive IoT communications between the UE and the one or more passive IoT devices; and performing the set of passive IoT communications with the one or more passive IoT devices using the set of time and frequency resources indicated by the scheduling grant.

Aspect 2: The method of aspect 1, wherein transmitting the passive IoT traffic report comprises: signaling a quantity of the one or more passive IoT devices in the passive IoT traffic report.

Aspect 3: The method of aspect 2, wherein a quantity of resources in the set of time and frequency resources indicated by the scheduling grant corresponds to the quantity of the one or more passive IoT devices signaled by the passive IoT traffic report.

Aspect 4: The method of aspect 1, wherein transmitting the passive IoT traffic report comprises: signaling a default value corresponding to an unknown quantity of the one or more passive IoT devices in the passive IoT traffic report.

Aspect 5: The method of aspect 4, wherein a quantity of resources in the set of time and frequency resources indicated by the scheduling grant corresponds to the default value signaled by the passive IoT traffic report.

Aspect 6: The method of any of aspects 1 through 5, wherein transmitting the passive IoT traffic report comprises: signaling a cast type associated with the set of passive IoT communications in the passive IoT traffic report, wherein the cast type comprises one or more of a broadcast type, a unicast type, or a groupcast type.

Aspect 7: The method of aspect 6, wherein the cast type signaled in the passive IoT traffic report indicates a quantity of the one or more passive IoT devices.

Aspect 8: The method of any of aspects 1 through 7, further comprising: transmitting a message that indicates collision information associated with the set of passive IoT communications, an estimated time duration of the set of passive IoT communications, or both.

Aspect 9: The method of aspect 8, wherein the collision information indicates a probability of collisions occurring during the set of passive IoT communications, a probability of the set of time and frequency resources including unused slots, or both.

Aspect 10: The method of any of aspects 8 through 9, further comprising: receiving, based at least in part on the message, a second scheduling grant that indicates a second set of time and frequency resources allocated for the set of passive IoT communications.

Aspect 11: The method of any of aspects 1 through 10, further comprising: transmitting a request for a second scheduling grant based at least in part on a quantity of the one or more passive IoT devices, an estimated time duration of the set of passive IoT communications, a quantity of resources allocated by the scheduling grant, a time duration of resources allocated by the scheduling grant, or a combination thereof; and receiving the second scheduling grant based at least in part on a time duration between transmission of the request and a start of the second scheduling grant satisfying a threshold, wherein the second scheduling grant indicates a second set of time and frequency resources allocated for the set of passive IoT communications.

Aspect 12: The method of any of aspects 1 through 11, further comprising: transmitting a request for a continuous scheduling grant within a time duration of the set of time and frequency resources; and performing the set of passive IoT communications using a second set of time and frequency resources in accordance with the continuous scheduling grant.

Aspect 13: The method of any of aspects 1 through 12, further comprising: transmitting an indication of at least one unused time or frequency resource upon completion of the set of passive IoT communications.

Aspect 14: A method for wireless communication at a network entity, comprising: obtaining a passive IoT traffic report that indicates a set of passive IoT communications to be performed between a UE and one or more passive IoT devices; determining a set of time and frequency resources to allocate for the set of passive IoT communications between the UE and the one or more passive IoT devices based at least in part on the passive IoT traffic report; and outputting a scheduling grant that indicates the set of time and frequency resources allocated for the set of passive IoT communications between the UE and the one or more passive IoT devices.

Aspect 15: The method of aspect 14, wherein the passive IoT traffic report signals a quantity of the one or more passive IoT devices.

Aspect 16: The method of aspect 15, wherein determining the set of time and frequency resources comprises: determining a quantity of resources to include in the set of time and frequency resources based at least in part on the quantity of the one or more passive IoT devices signaled by the passive IoT traffic report.

Aspect 17: The method of aspect 14, wherein the passive IoT traffic report signals a default value corresponding to an unknown quantity of the one or more passive IoT devices.

Aspect 18: The method of aspect 17, wherein determining the set of time and frequency resources comprises: determining a quantity of resources to include in the set of time and frequency resources based at least in part on the default value signaled by the passive IoT traffic report.

Aspect 19: The method of any of aspects 14 through 18, wherein the passive IoT traffic report signals a cast type associated with the set of passive IoT communications, the cast type comprising one or more of a broadcast type, a unicast type, or a groupcast type.

Aspect 20: The method of aspect 19, further comprising: determining a quantity of the one or more passive IoT devices based at least in part on the cast type signaled in the passive IoT traffic report.

Aspect 21: The method of any of aspects 14 through 20, further comprising: obtaining a message that indicates collision information associated with the set of passive IoT communications, an estimated time duration of the set of passive IoT communications, or both.

Aspect 22: The method of aspect 21, wherein the collision information indicates a probability of collisions occurring during the set of passive IoT communications, a probability of the set of time and frequency resources including unused slots, or both.

Aspect 23: The method of any of aspects 21 through 22, further comprising: outputting a second scheduling grant that indicates a second set of time and frequency resources allocated for the set of passive IoT communications based at least in part on the message.

Aspect 24: The method of any of aspects 14 through 23, further comprising: obtaining a request for a continuous scheduling grant within a time duration of the set of time and frequency resources; and allocating a second set of time and frequency resources for the set of passive IoT communications in accordance with the continuous scheduling grant.

Aspect 25: The method of any of aspects 14 through 24, further comprising: receiving an indication of at least one unused time or frequency resource in the set of time and frequency resources allocated for the set of passive IoT communications; and allocating the at least one unused time or frequency resource to a second UE that is different from the UE.

Aspect 26: An apparatus for wireless communication at a UE, comprising at

least one processor and memory coupled to the at least one processor, the memory storing instructions executable by the at least one processor to cause the UE to perform a method of any of aspects 1 through 13.

Aspect 27: An apparatus for wireless communication at a UE, comprising at least one means for performing a method of any of aspects 1 through 13.

Aspect 28: A non-transitory computer-readable medium storing code for wireless communication at a UE, the code comprising instructions executable by at least one processor to cause the UE to perform a method of any of aspects 1 through 13.

Aspect 29: An apparatus for wireless communication at a network entity, comprising at least one processor and memory coupled to the at least one processor, the memory storing instructions executable by the at least one processor to cause the network entity to perform a method of any of aspects 14 through 25.

Aspect 30: An apparatus for wireless communication at a network entity, comprising at least one means for performing a method of any of aspects 14 through 25.

Aspect 31: A non-transitory computer-readable medium storing code for wireless communication at a network entity, the code comprising instructions executable by at least one processor to cause the network entity to perform a method of any of aspects 14 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by at least one processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by at least one processor, the functions may be stored on or transmitted over as one or more instructions or code on a computer-readable medium. Other examples and implementations are within the scope of the disclosure and appended claims. For example, due to the nature of software, functions described herein may be implemented using software executed by at least one processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (such as receiving information), or accessing (such as accessing data in a memory). Also, “determining” can include resolving, obtaining, selecting, choosing, establishing and other similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled to the at least one processor, the memory storing instructions executable by the at least one processor to cause the UE to:
transmit a passive Internet of Things (IoT) traffic report that indicates a set of passive IoT communications to be performed between the UE and one or more passive IoT devices;
receive, based at least in part on the passive IoT traffic report, a scheduling grant that indicates a set of time and frequency resources allocated for the set of passive IoT communications between the UE and the one or more passive IoT devices; and
perform the set of passive IoT communications with the one or more passive IoT devices using the set of time and frequency resources indicated by the scheduling grant.

2. The apparatus of claim 1, wherein the instructions to transmit the passive IoT traffic report are executable by the at least one processor to cause the UE to:
signal a quantity of the one or more passive IoT devices in the passive IoT traffic report.

3. The apparatus of claim 2, wherein a quantity of resources in the set of time and frequency resources indicated by the scheduling grant corresponds to the quantity of the one or more passive IoT devices signaled by the passive IoT traffic report.

4. The apparatus of claim 1, wherein the instructions to transmit the passive IoT traffic report are executable by the at least one processor to cause the UE to:
signal a default value corresponding to an unknown quantity of the one or more passive IoT devices in the passive IoT traffic report.

5. The apparatus of claim 4, wherein a quantity of resources in the set of time and frequency resources indicated by the scheduling grant corresponds to the default value signaled by the passive IoT traffic report.

6. The apparatus of claim 1, wherein the instructions to transmit the passive IoT traffic report are executable by the at least one processor to cause the UE to:
signal a cast type associated with the set of passive IoT communications in the passive IoT traffic report, wherein the cast type comprises one or more of a broadcast type, a unicast type, or a groupcast type.

7. The apparatus of claim 6, wherein the cast type signaled in the passive IoT traffic report indicates a quantity of the one or more passive IoT devices.

8. The apparatus of claim 1, wherein the instructions are further executable by the at least one processor to cause the UE to:
transmit a message that indicates collision information associated with the set of passive IoT communications, an estimated time duration of the set of passive IoT communications, or both.

9. The apparatus of claim 8, wherein the collision information indicates a probability of collisions occurring during the set of passive IoT communications, a probability of the set of time and frequency resources including unused slots, or both.

10. The apparatus of claim 8, wherein the instructions are further executable by the at least one processor to cause the UE to:
receive, based at least in part on the message, a second scheduling grant that indicates a second set of time and frequency resources allocated for the set of passive IoT communications.

11. The apparatus of claim 1, wherein the instructions are further executable by the at least one processor to cause the UE to:
transmit a request for a second scheduling grant based at least in part on a quantity of the one or more passive IoT devices, an estimated time duration of the set of passive IoT communications, a quantity of resources allocated by the scheduling grant, a time duration of resources allocated by the scheduling grant, or a combination thereof; and
receive the second scheduling grant based at least in part on a time duration between transmission of the request and a start of the second scheduling grant satisfying a threshold, wherein the second scheduling grant indicates a second set of time and frequency resources allocated for the set of passive IoT communications.

12. The apparatus of claim 1, wherein the instructions are further executable by the at least one processor to cause the UE to:
transmit a request for a continuous scheduling grant within a time duration of the set of time and frequency resources; and
perform the set of passive IoT communications using a second set of time and frequency resources in accordance with the continuous scheduling grant.

13. The apparatus of claim 1, wherein the instructions are further executable by the at least one processor to cause the UE to:
transmit an indication of at least one unused time or frequency resource upon completion of the set of passive IoT communications.

14. An apparatus for wireless communication at a network entity, comprising:
at least one processor; and
memory coupled to the at least one processor, the memory storing instructions executable by the at least one processor to cause the network entity to:
obtain a passive Internet of Things (IoT) traffic report that indicates a set of passive IoT communications to be performed between a user equipment (UE) and one or more passive IoT devices;
determine a set of time and frequency resources to allocate for the set of passive IoT communications between the UE and the one or more passive IoT devices based at least in part on the passive IoT traffic report; and
output a scheduling grant that indicates the set of time and frequency resources allocated for the set of passive IoT communications between the UE and the one or more passive IoT devices.

15. The apparatus of claim 14, wherein the passive IoT traffic report signals a quantity of the one or more passive IoT devices.

16. The apparatus of claim 15, wherein the instructions to determine the set of time and frequency resources are executable by the at least one processor to cause the network entity to:
determine a quantity of resources to include in the set of time and frequency resources based at least in part on the quantity of the one or more passive IoT devices signaled by the passive IoT traffic report.

17. The apparatus of claim 14, wherein the passive IoT traffic report signals a default value corresponding to an unknown quantity of the one or more passive IoT devices.

18. The apparatus of claim 17, wherein the instructions to determine the set of time and frequency resources are executable by the at least one processor to cause the network entity to:
determine a quantity of resources to include in the set of time and frequency resources based at least in part on the default value signaled by the passive IoT traffic report.

19. The apparatus of claim 14, wherein the passive IoT traffic report signals a cast type associated with the set of passive IoT communications, the cast type comprising one or more of a broadcast type, a unicast type, or a groupcast type.

20. The apparatus of claim 19, wherein the instructions are further executable by the at least one processor to cause the network entity to:
determine a quantity of the one or more passive IoT devices based at least in part on the cast type signaled in the passive IoT traffic report.

21. The apparatus of claim 14, wherein the instructions are further executable by the at least one processor to cause the network entity to:
obtain a message that indicates collision information associated with the set of passive IoT communications, an estimated time duration of the set of passive IoT communications, or both.

22. The apparatus of claim 21, wherein the collision information indicates a probability of collisions occurring during the set of passive IoT communications, a probability of the set of time and frequency resources including unused slots, or both.

23. The apparatus of claim 21, wherein the instructions are further executable by the at least one processor to cause the network entity to:
output a second scheduling grant that indicates a second set of time and frequency resources allocated for the set of passive IoT communications based at least in part on the message.

24. The apparatus of claim 14, wherein the instructions are further executable by the at least one processor to cause the network entity to:
obtain a request for a continuous scheduling grant within a time duration of the set of time and frequency resources; and
allocate a second set of time and frequency resources for the set of passive IoT communications in accordance with the continuous scheduling grant.

25. The apparatus of claim 14, wherein the instructions are further executable by the at least one processor to cause the network entity to:
receive an indication of at least one unused time or frequency resource in the set of time and frequency resources allocated for the set of passive IoT communications; and
allocate the at least one unused time or frequency resource to a second UE that is different from the UE.

26. A method for wireless communication at a user equipment (UE), comprising:
transmitting a passive Internet of Things (IoT) traffic report that indicates a set of passive IoT communications to be performed between the UE and one or more passive IoT devices;
receiving, based at least in part on the passive IoT traffic report, a scheduling grant that indicates a set of time and frequency resources allocated for the set of passive IoT communications between the UE and the one or more passive IoT devices; and
performing the set of passive IoT communications with the one or more passive IoT devices using the set of time and frequency resources indicated by the scheduling grant.

27. The method of claim 26, wherein transmitting the passive IoT traffic report comprises:
signaling a quantity of the one or more passive IoT devices in the passive IoT traffic report.

28. The method of claim 26, wherein transmitting the passive IoT traffic report comprises:
signaling a default value corresponding to an unknown quantity of the one or more passive IoT devices in the passive IoT traffic report.

29. The method of claim 26, further comprising:
transmitting a request for a second scheduling grant based at least in part on a quantity of the one or more passive IoT devices, an estimated time duration of the set of passive IoT communications, a quantity of resources allocated by the scheduling grant, a time duration of resources allocated by the scheduling grant, or a combination thereof; and
receiving the second scheduling grant based at least in part on a time duration between transmission of the request and a start of the second scheduling grant satisfying a threshold, wherein the second scheduling grant indicates a second set of time and frequency resources allocated for the set of passive IoT communications.

30. A method for wireless communication at a network entity, comprising:
obtaining a passive Internet of Things (IoT) traffic report that indicates a set of passive IoT communications to be performed between a user equipment (UE) and one or more passive IoT devices;
determining a set of time and frequency resources to allocate for the set of passive IoT communications between the UE and the one or more passive IoT devices based at least in part on the passive IoT traffic report; and
outputting a scheduling grant that indicates the set of time and frequency resources allocated for the set of passive IoT communications between the UE and the one or more passive IoT devices.
